(19) United States
(12) Patent Application Publication
(10) Pub. No.: US 2025/0089596 A1
(43) Pub. Date: Mar. 20, 2025

(54) AGRICULTURAL MANAGEMENT SYSTEM

(71) Applicant: Kubota Corporation, Osaka (JP)

(72) Inventors: Shunsuke EDO, Sakai-shi (JP); Shunsuke MIYASHITA, Sakai-shi (JP)

(21) Appl. No.: 18/969,551

(22) Filed: Dec. 5, 2024

Related U.S. Application Data
(63) Continuation of application No. PCT/JP2023/020863, filed on Jun. 5, 2023.

(30) Foreign Application Priority Data
Jun. 8, 2022 (JP) 2022-092949

(51) Int. Cl. A01B 76/00; B60W 30/08

(52) U.S. Cl. CPC A01B 76/00; B60W 30/08; B60W 2300/15

(57) ABSTRACT

An agricultural management system includes a server configured or programmed to obtain implement information concerning a plurality of types of implements from a plurality of users and store the obtained implement information, and a processor configured or programmed to set a size of an alert zone around an implement connected with a work vehicle. The processor is configured or programmed to obtain identification information which identifies the first implement, retrieve implement information corresponding to the identification information from the server, and set the size of the alert zone based on the retrieved implement information.

### CROSS REFERENCE TO RELATED APPLICATIONS

This application claims the benefit of priority to Japanese Patent Application No. 2022-092949 filed on Jun. 8, 2022 and is a Continuation Application of PCT Application No. PCT/JP2023/020863 filed on Jun. 5, 2023. The entire contents of each application are hereby incorporated herein by reference.

### BACKGROUND OF THE INVENTION

### 1. Field of the Invention

The present disclosure relates to agricultural management systems.

### 2. Description of the Related Art

Research and development is underway to study smart agriculture with the effective use of ICT (Information and Communication Technology) and IoT (Internet of Things) as the next generation of agriculture. Research and development is also underway to study automated and unmanned work vehicles, such as tractors, for use in agricultural fields. For example, work vehicles capable of traveling in an automatic steering mode with the use of a positioning system such as GNSS (Global Navigation Satellite System), which is capable of precise positioning, have been put into practical use.

In addition, research and development is also underway to study the technique of conducting a search of a region around a work vehicle with the use of obstacle sensors to detect obstacles around the work vehicle. For example, Japanese Laid-Open Patent Publication No. 2019-175059 discloses the technique of detecting obstacles around a self-drivable tractor with the use of LiDAR (Light Detection and Ranging) sensors.

### SUMMARY OF THE INVENTION

When an implement is connected with a work vehicle, the work vehicle can perform agricultural work using the implement while automatically traveling in a field.

In some cases, it is desirable that humans do not enter an area near the implement that is performing work in an automatic operation mode. One possible solution is to set an alert zone around the implement and detect whether or not a human is present in that alert zone.

Example embodiments of the present invention provide techniques for setting an alert zone suitable for an implement connected with a work vehicle.

An agricultural management system according to an example embodiment of the present disclosure includes a server configured or programmed to obtain implement information concerning a plurality of types of implements from a plurality of users and store the obtained implement information, and a processor configured or programmed to set a size of an alert zone around a first implement connected with a work vehicle, wherein the processor is configured or programmed to obtain identification information which identifies the first implement, retrieve implement information corresponding to the identification information from the server, and set the size of the alert zone based on the retrieved implement information.

Example embodiments of the present disclosure may be implemented using devices, systems, methods, integrated circuits, computer programs, non-transitory computer-readable storage media, or any combination thereof. The computer-readable storage media may include volatile storage media or non-volatile storage media. Each of the devices may include a plurality of devices. In the case where one of the devices includes two or more devices, the two or more devices may be disposed within a single apparatus, or divided over two or more separate apparatuses.

According to an example embodiment of the present disclosure, implement information concerning a plurality of types of implements, which is provided by a plurality of users, is obtained, and the obtained implement information is accumulated in a server. The processor is configured or programmed to retrieve implement information corresponding to identification information of an implement connected with a work vehicle from the server and sets the size of the alert zone based on the retrieved implement information.

Even when using an implement, the information of which necessary for setting the size of the alert zone is not disclosed by the manufacturer, it is possible to set the size of the alert zone suitable for each implement by using the implement information provided by the users.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram providing an overview of an agriculture management system according to an illustrative example embodiment of the present disclosure.

FIG. 2 is a side view schematically showing an example of work vehicle and an example of implement that is linked to the work vehicle.

FIG. 3 is a block diagram showing an example configuration of the work vehicle and the implement.

FIG. 4 is a conceptual diagram showing an example of the work vehicle performing positioning based on an RTK-GNSS.

FIG. 5 is a diagram showing an example of operational terminal and an example of operation switches disposed in a cabin.

FIG. 6 is a block diagram showing an example of hardware configuration of a management device and a terminal device.

FIG. 7 is a diagram schematically showing an example of the work vehicle automatically traveling along a target path inside a field.

FIG. 8 is a flowchart showing an example operation of steering control during self-driving.

FIG. 9A is a diagram showing an example of the work vehicle traveling along a target path P.

FIG. 9B is a diagram showing an example of the work vehicle at a position which is shifted rightward from the target path P.

FIG. 9C is a diagram showing an example of the work vehicle at a position which is shifted leftward from the target path P.

FIG. 9D is a diagram showing an example of the work vehicle oriented in an inclined direction with respect to the target path P.

FIG. 10 is a diagram schematically showing an example of state where a plurality of the work vehicles perform self-traveling inside a field and on a road outside the field.

FIG. 11 is a diagram showing an example of a sensing region sensed by sensors.

FIG. 12 shows the relationship between sensing regions sensed by LiDAR sensors and search regions in which a search for objects is to be conducted.

FIG. 13 is a diagram showing the relationship between the search regions and the alert zone.

FIG. 14 is a diagram showing an agricultural management system 1 wherein implement information provided by a plurality of users is accumulated in a server.

FIG. 15 is a diagram showing an example of an input window for implement information, which is displayed on the display of the terminal device.

FIG. 16 is a diagram showing an example of the implement information stored in the server.

FIG. 17 is a diagram showing an example of the implement information stored in the server.

FIG. 18 is a flowchart showing an example of the process of setting an alert zone using the implement information stored in the server.

FIG. 19 is a block diagram showing an example of the hardware configuration of the implement.

FIG. 20 is a diagram showing an example of the method of calculating the position of at least a portion of the external shape of an implement in a local coordinate system.

FIG. 21 is a diagram showing an example of the alert zone set around the implement.

FIG. 22 is a flowchart showing an example of a process that is performed if it is determined that a human is present in the alert zone.

FIG. 23 is a diagram showing an example of the method of calculating the position of at least a portion of the external shape of an implement in a local coordinate system.

FIG. 24 is a diagram showing an example of the alert zone set around the implement.

FIG. 25 is a diagram showing an example of a plurality of alert zones.

### DETAILED DESCRIPTION OF THE EXAMPLE EMBODIMENTS

In the present disclosure, an “agricultural machine” refers to a machine for agricultural applications. The agricultural machine of the present disclosure can be a mobile agricultural machine that is capable of performing agricultural work while traveling. Examples of agricultural machines include tractors, harvesters, rice transplanters, vehicles for crop management, vegetable transplanters, mowers, seeders, spreaders, and mobile robots for agriculture. Not only may a work vehicle such as a tractor function as an “agricultural machine” alone by itself, but also a combination of a work vehicle and an implement that is attached to, or towed by, the work vehicle may function as an “agricultural machine”. For the ground surface inside a field, the agricultural machine performs agricultural work such as tilling, seeding, preventive pest control, manure spreading, planting of crops, or harvesting. Such agricultural work or tasks may be referred to as “groundwork”, or simply as “work” or “tasks”. Travel of a vehicle-type agricultural machine performed while the agricultural machine also performs agricultural work may be referred to as “tasked travel”.

“Self-driving” refers to controlling the movement of an agricultural machine by the action of a controller, rather than through manual operations of a driver. An agricultural machine that performs self-driving may be referred to as a “self-driving agricultural machine” or a “robotic agricultural machine”. During self-driving, not only the movement of the agricultural machine, but also the operation of agricultural work (e.g., the operation of the implement) may be controlled automatically. In the case where the agricultural machine is a vehicle-type machine, travel of the agricultural machine via self-driving will be referred to as “self-traveling”. The controller may be configured or programmed to control at least one of steering that is required in the movement of the agricultural machine, adjustment of the moving speed, or beginning and ending of a move. In the case of controlling a work vehicle having an implement attached thereto, the controller may be configured or programmed to control raising or lowering of the implement, beginning and ending of an operation of the implement, and so on. A move based on self-driving may include not only moving of an agricultural machine that goes along a predetermined path toward a destination, but also moving of an agricultural machine that follows a target of tracking. An agricultural machine that performs self-driving may also move partly based on the user's instructions. Moreover, an agricultural machine that performs self-driving may operate not only in a self-driving mode but also in a manual driving mode, where the agricultural machine moves through manual operations of the driver. When performed not manually but through the action of a controller, the steering of an agricultural machine will be referred to as “automatic steering”. A portion of, or the entirety of, the controller may reside outside the agricultural machine. Control signals, commands, data, etc. may be communicated between the agricultural machine and a controller residing outside the agricultural machine. An agricultural machine that performs self-driving may move autonomously while sensing the surrounding environment, without any person being involved in the controlling of the movement of the agricultural machine. An agricultural machine that is capable of autonomous movement is able to travel inside the field or outside the field (e.g., on roads) in an unmanned manner. During an autonomous move, operations of detecting and avoiding obstacles may be performed.

A “work plan” is data defining a plan of one or more tasks of agricultural work to be performed by an agricultural machine. The work plan may include, for example, information representing the order of the tasks of agricultural work to be performed by an agricultural machine or the field where each of the tasks of agricultural work is to be performed. The work plan may include information representing the time and the date when each of the tasks of agricultural work is to be performed. The work plan may be created by a processor communicating with the agricultural machine to manage the agricultural machine or a processor mounted on the agricultural machine. The processor can be configured or programmed to create a work plan based on, for example, information input by the user (agricultural business executive, agricultural worker, etc.) manipulating a terminal device. In this specification, the processor communicating with the agricultural machine to manage the agricultural machine will be referred to as a “management device”. The management device may manage agricultural work of a plurality agricultural machines. In this case, the management device may create a work plan including information on each task of agricultural work to be performed by each of the plurality of agricultural machines. The work plan may be downloaded to each of the agricultural machines and stored in a storage device in each of the agricultural machines. In order to perform the scheduled agricultural work in accordance with the work plan, each agricultural machine can automatically move to a field and perform the agricultural work.

An “environment map” is data representing, with a predetermined coordinate system, the position or the region of an object existing in the environment where the agricultural machine moves. The environment map may be referred to simply as a “map” or “map data”. The coordinate system defining the environment map is, for example, a world coordinate system such as a geographic coordinate system fixed to the globe. Regarding the object existing in the environment, the environment map may include information other than the position (e.g., attribute information or other types of information). The “environment map” encompasses various type of maps such as a point cloud map and a lattice map. Data on a local map or a partial map that is generated or processed in a process of constructing the environment map is also referred to as a “map” or “map data”.

An “agricultural road” is a road used mainly for agriculture. An “agricultural road” is not limited to a road paved with asphalt, and encompasses unpaved roads covered with soil, gravel or the like. An “agricultural road” encompasses roads (including private roads) on which only vehicle-type agricultural machines (e.g., work vehicles such as tractors, etc.) are allowed to travel and roads on which general vehicles (automobiles, trucks, buses, etc.) are also allowed to travel. The work vehicles may automatically travel on a general road in addition to an agricultural road. The “general road” is a road maintained for traffic of general vehicles.

Hereinafter, example embodiments of the present disclosure will be described. Note, however, that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of the claims. In the following description, elements having identical or similar functions are denoted by identical reference numerals.

The following example embodiments are only exemplary, and the techniques according to the present disclosure are not limited to the following example embodiments. For example, numerical values, shapes, materials, steps, orders of steps, layout of a display screen, etc. which are indicated in the following example embodiments are only exemplary, and allow for various modifications so long as it makes technological sense. Any one implementation may be combined with another so long as it makes technological sense to do so.

Hereinafter, example embodiments in which techniques according to the present disclosure are applied to work vehicles, such as tractors, which are examples of agricultural machines, will be mainly described. The techniques and example embodiments according to the present disclosure are also applicable to other types of agricultural machines in addition to the work vehicles such as tractors.

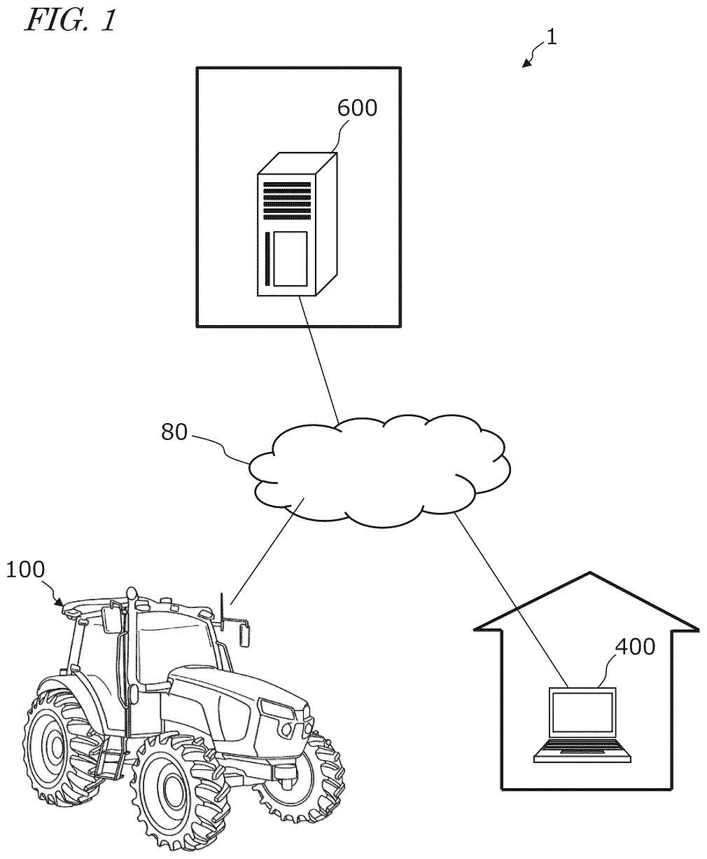

FIG. 1 is a diagram providing an overview of an agriculture management system 1 according to an illustrative example embodiment of the present disclosure. The agriculture management system 1 shown in FIG. 1 includes a work vehicle 100, a terminal device 400, and a management device 600. The terminal device 400 is a computer usable by a user performing remote monitoring of the work vehicle 100. The management device 600 is a computer manageable by a business operator running the agriculture management system 1. The work vehicle 100, the terminal device 400 and the management device 600 can communicate with each other via the network 80. FIG. 1 shows one work vehicle 100, but the agriculture management system 1 may include a plurality of the work vehicles or any other agricultural machine.

The work vehicle 100 according to the present example embodiment is a tractor. The work vehicle 100 can have an implement attached to its rear and/or its front. While performing agricultural work in accordance with the type of the implement, the work vehicle 100 is able to travel inside a field. The work vehicle 100 may travel inside the field or outside the field with no implement being attached thereto.

The work vehicle 100 has a self-driving function. In other words, the work vehicle 100 can travel by the action of a controller, rather than manually. The controller according to the present example embodiment is provided in or on the work vehicle 100, and is configured or programmed to control both the speed and steering of the work vehicle 100. The work vehicle 100 can perform self-traveling outside the field (e.g., on roads) as well as inside the field.

The work vehicle 100 includes a device usable for positioning or localization, such as a GNSS receiver or an LiDAR sensor. Based on the position of the work vehicle 100 and information on a target path, the controller of the work vehicle 100 is configured or programmed to cause the work vehicle 100 to automatically travel. In addition to controlling the travel of the work vehicle 100, the controller also is configured or programmed to control the operation of the implement. As a result, while automatically traveling inside the field, the work vehicle 100 is able to perform agricultural work by using the implement. In addition, the work vehicle 100 is able to automatically travel along the target path on a road outside the field (e.g., an agricultural road or a general road). The work vehicle 100 travels in a self-traveling mode along roads outside the field with the effective use of data output from sensors, such as the cameras 120, the obstacle sensors 130 and the LiDAR sensor 140.

The management device 600 is a computer to manage the agricultural work performed by the work vehicle 100. The management device 600 may be, for example, a server computer configured or programmed to perform centralized management on information regarding the field on the cloud and supports agriculture by use of the data on the cloud. The management device 600, for example, creates a work plan for the work vehicle 100 and causes the work vehicle 100 to execute agricultural work in accordance with the work plan. The management device 600 generates a target path in the field based on, for example, the information entered by a user using the terminal unit 400 or any other device. The management device 600 may generate and edit an environment map based on data collected by the work vehicle 100 or any other movable body by use of the sensor such as a LiDAR sensor. The management device 600 transmits data on the work plan, the target path and the environment map thus generated to the work vehicle 100. The work vehicle 100 automatically moves and performs agricultural work based on the data.

The terminal device 400 is a computer that is usable by a user who is at a remote place from the work vehicle 100. The terminal device 400 shown in FIG. 1 is a laptop computer, but the terminal device 400 is not limited to this. The terminal device 400 may be a stationary computer such as a desktop PC (personal computer), or a mobile terminal such as a smartphone or a tablet computer. The terminal device 400 may be used to perform remote monitoring of the work vehicle 100 or remote-manipulate the work vehicle 100. For example, the terminal device 400 can display, on a display screen thereof, a video captured by one or more cameras (imagers) included in the work vehicle 100. The terminal device 400 can also display, on the display screen thereof, a setting screen allowing the user to input information necessary to create a work plan (e.g., a schedule of each task of agricultural work) for the work vehicle 100. When the user inputs necessary information to the setting screen and performs a manipulation to transmit the information, the terminal device 400 transmits the input information to the management device 600. The management device 600 creates a work plan based on the information. The terminal device 400 may further have a function of displaying, on a display screen thereof, a setting screen allowing the user to input information necessary to set a target path.

Hereinafter, a configuration and an operation of the system according to the present example embodiment will be described in more detail.

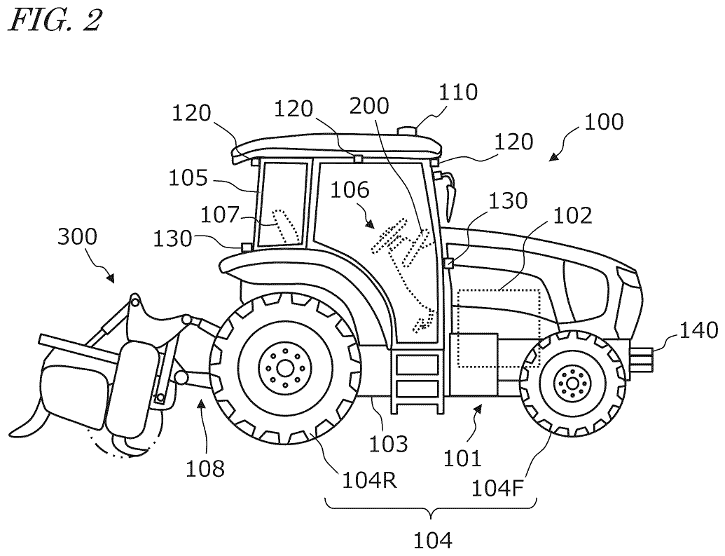

FIG. 2 is a side view schematically showing an example of the work vehicle 100 and an example of implement 300 linked to the work vehicle 100. The work vehicle 100 according to the present example embodiment can operate both in a manual driving mode and a self-driving mode. In the self-driving mode, the work vehicle 100 is able to perform unmanned travel. The work vehicle 100 can perform self-driving both inside a field and outside the field.

As shown in FIG. 2, the work vehicle 100 includes a vehicle body 101, a prime mover (engine) 102, and a transmission 103. On the vehicle body 101, wheels 104 with tires and a cabin 105 are provided. The wheels 104 include a pair of front wheels 104F and a pair of rear wheels 104R. Inside the cabin 105, a driver's seat 107, a steering device 106, an operational terminal 200, and switches for manipulation are provided. In the case where the work vehicle 100 performs tasked travel inside the field, either or both of the front wheels 104F and the rear wheels 104R may be a plurality of wheels (crawlers) with a continuous track rather than wheels with tires.

The work vehicle 100 can include at least one sensor to sense the environment around the work vehicle 100 and a processor to process sensor data output from the at least one sensor. In the example shown in FIG. 2, the work vehicle 100 includes a plurality of sensors. The sensors include a plurality of cameras 120, a LiDAR sensor 140, and a plurality of obstacle sensors 130.

The cameras 120 may be provided at the front/rear/right/left of the work vehicle 100, for example. The cameras 120 image the environment around the work vehicle 100 and generate image data. The images acquired by the cameras 120 can be output to a processor included in the work vehicle 100 and transmitted to the terminal device 400, which is responsible for remote monitoring. Also, the images may be used to monitor the work vehicle 100 during unmanned driving. The cameras 120 may also be used to generate images to allow the work vehicle 100, traveling on a road outside the field (an agricultural road or a general road), to recognize objects, obstacles, white lines, road signs, traffic signs or the like in the surroundings of the work vehicle 100.

The LiDAR sensor 140 in the example shown in FIG. 2 is disposed on a bottom portion of a front surface of the vehicle body 101. The LiDAR sensor 140 may be disposed at any other position. For example, the LiDAR sensor 140 may be provided at the upper portion of the cabin 105. The LiDAR sensor 140 can be a 3D-LiDAR sensor but may be a 2D-LiDAR sensor. The LiDAR sensor 140 senses the environment around the work vehicle 100 to output sensor data. While the work vehicle 100 is traveling mainly outside the field, the LiDAR sensor 140 repeatedly outputs sensor data representing the distance and the direction between an object existing in the environment around the work vehicle 100 and each of measurement points, or three-dimensional or two-dimensional coordinate values of each of the measurement points. The sensor data output from the LiDAR sensor 140 is processed by the controller of the work vehicle 100. The controller can perform localization of the work vehicle 100 by matching the sensor data against the environment map. The controller can further detect an object such as an obstacle existing in the surroundings of the work vehicle 100 based on the sensor data. The controller can utilize an algorithm such as, for example, SLAM (Simultaneous Localization and Mapping) to generate or edit an environment map. The work vehicle 100 may include a plurality of LiDAR sensors disposed at different positions with different orientations.

The plurality of obstacle sensors 130 shown in FIG. 2 are provided at the front and the rear of the cabin 105. The obstacle sensors 130 may be disposed at other positions. For example, one or more obstacle sensors 130 may be disposed at any position at the sides, the front or the rear of the vehicle body 101. The obstacle sensors 130 may include, for example, a laser scanner or an ultrasonic sonar. The obstacle sensors 130 may be used to detect obstacles around the work vehicle 100 during self-traveling to cause the work vehicle 100 to halt or detour around the obstacles. The LiDAR sensor 140 may be used as one of the obstacle sensors 130.

The work vehicle 100 further includes a GNSS unit 110. The GNSS unit 110 includes a GNSS receiver. The GNSS receiver may include an antenna to receive a signal(s) from a GNSS satellite(s) and a processor to calculate the position of the work vehicle 100 based on the signal(s) received by the antenna. The GNSS unit 110 receives satellite signals transmitted from the plurality of GNSS satellites, and performs positioning based on the satellite signals. GNSS is the general term for satellite positioning systems such as GPS (Global Positioning System), QZSS (Quasi-Zenith Satellite System; e.g., MICHIBIKI), GLONASS, Galileo, and BeiDou. Although the GNSS unit 110 according to the present example embodiment is disposed above the cabin 105, it may be disposed at any other position.

The GNSS unit 110 may include an inertial measurement unit (IMU). Signals from the IMU can be used to complement position data. The IMU can measure a tilt or a small motion of the work vehicle 100. The data acquired by the IMU can be used to complement the position data based on the satellite signals, so as to improve the performance of positioning.

The controller of the work vehicle 100 may utilize, for positioning, the sensor data acquired by the sensors such as the cameras 120 and/or the LIDAR sensor 140, in addition to the positioning results provided by the GNSS unit 110. In the case where objects serving as characteristic points exist in the environment that is traveled by the work vehicle 100, as in the case of an agricultural road, a forest road, a general road or an orchard, the position and the orientation of the work vehicle 100 can be estimated with a high accuracy based on data that is acquired by the cameras 120 and/or the LiDAR sensor 140 and on an environment map that is previously stored in the storage device. By correcting or complementing position data based on the satellite signals using the data acquired by the cameras 120 and/or the LiDAR sensor 140, it becomes possible to identify the position of the work vehicle 100 with a higher accuracy.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the steered wheels, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force to change the steering angle of the front wheels 104F. When automatic steering is performed, under the control of the controller disposed in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point link” or a “three-point hitch”), a PTO (Power Take Off) shaft, a universal joint, and a communication cable. The linkage device 108 allows the implement 300 to be attached to, or detached from, the work vehicle 100. The linkage device 108 is able to raise or lower the three-point link with a hydraulic device, for example, thus changing the position and/or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided at the front portion of the vehicle body 101. In that case, the implement 300 can be connected with the front portion of the work vehicle 100.

Although the implement 300 shown in FIG. 2 is a rotary tiller, the implement 300 is not limited to a rotary tiller. For example, any arbitrary implement such as a seeder, a spreader, a transplanter, a mower, a rake implement, a baler, a harvester, a sprayer, or a harrow, can be connected to the work vehicle 100 for use.

The work vehicle 100 shown in FIG. 2 can be driven by human driving; alternatively, it may only support unmanned driving. In that case, component elements which are only required for human driving, e.g., the cabin 105, the steering device 106, and the driver's seat 107 do not need to be provided in the work vehicle 100. An unmanned work vehicle 100 can travel via autonomous driving, or by remote operation by a user.

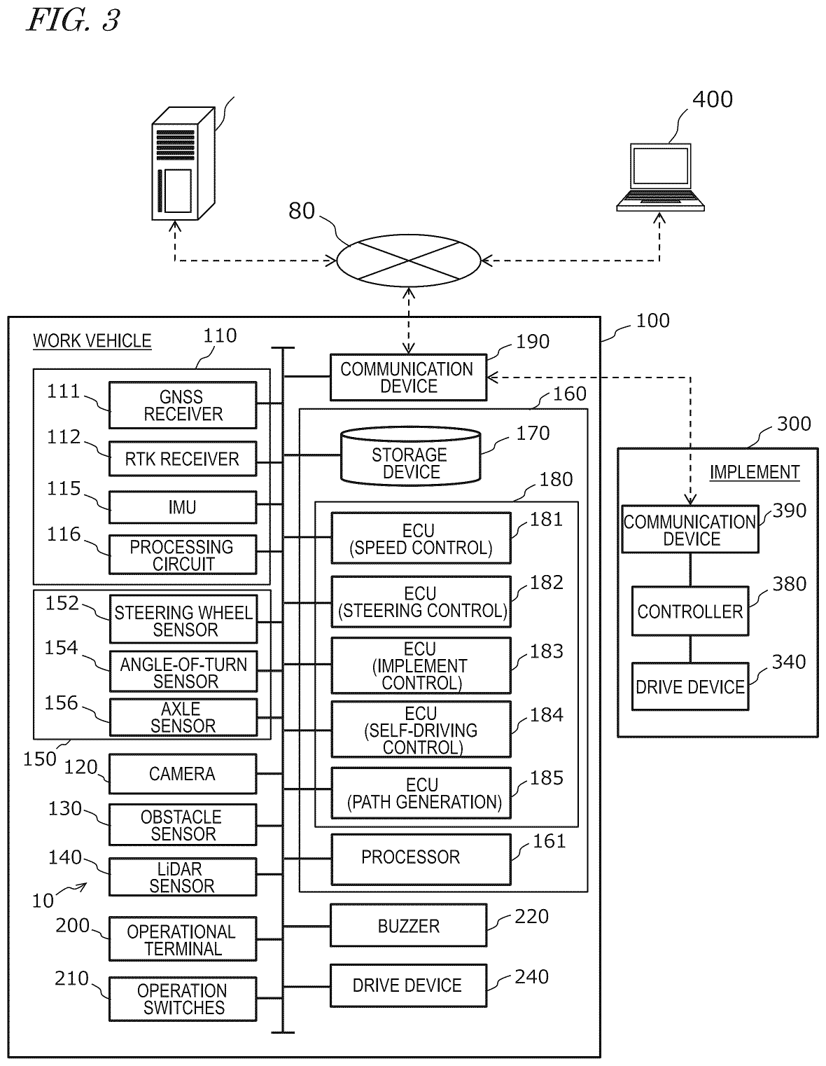

FIG. 3 is a block diagram showing an example configuration of the work vehicle 100 and the implement 300. The work vehicle 100 and the implement 300 can communicate with each other via a communication cable that is included in the linkage device 108. The work vehicle 100 is able to communicate with the terminal device 400 and the management device 600 via the network 80.

In addition to the GNSS unit 110, the cameras 120, the obstacle sensors 130, the LiDAR sensor 140 and the operational terminal 200, the work vehicle 100 in the example of FIG. 3 includes sensors 150 to detect the operating status of the work vehicle 100, a control system 160, a communication device 190, operation switches 210, a buzzer 220, and a drive device 240. These component elements are communicably connected to each other via a bus. The GNSS unit 110 includes a GNSS receiver 111, an RTK receiver 112, an inertial measurement unit (IMU) 115, and a processing circuit 116. The sensors 150 include a steering wheel sensor 152, an angle-of-turn sensor 154, and an axle sensor 156. The control system 160 includes a processor 161, a storage device 170 and a controller 180. The controller 180 includes a plurality of electronic control units (ECU) 181 to 185. The implement 300 includes a drive device 340, a controller 380, and a communication device 390. Note that FIG. 3 shows component elements which are relatively closely related to the operations of self-driving by the work vehicle 100, while other components are omitted from illustration.

The GNSS receiver 111 in the GNSS unit 110 receives satellite signals from transmitted the plurality of GNSS satellites and generates GNSS data based on the satellite signals. The GNSS data is generated in a predetermined format such as, for example, the NMEA-0183 format. The GNSS data may include, for example, the identification number, the angle of elevation, the azimuth angle, and a value representing the reception strength of each of the satellites from which the satellite signals are received.

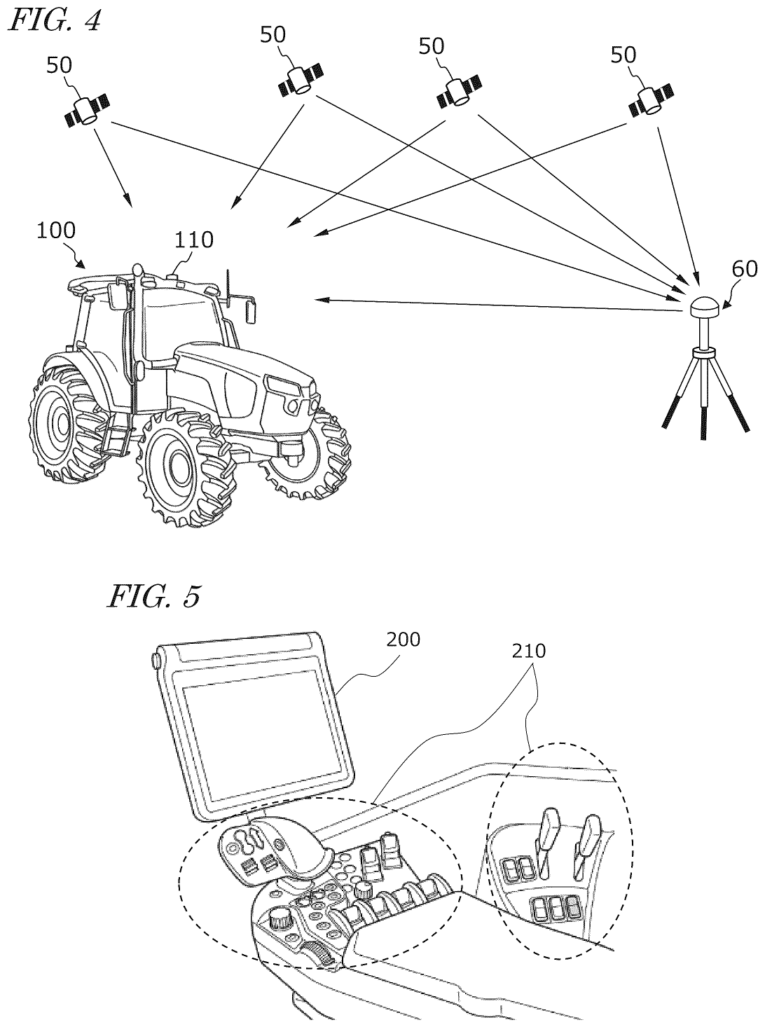

The GNSS unit 110 shown in FIG. 3 performs positioning of the work vehicle 100 by utilizing an RTK (Real Time Kinematic)-GNSS. FIG. 4 is a conceptual diagram showing an example of the work vehicle 100 performing positioning based on the RTK-GNSS. In the positioning based on the RTK-GNSS, not only satellite signals transmitted from a plurality of GNSS satellites 50, but also a correction signal that is transmitted from a reference station 60 is used. The reference station 60 may be disposed near the field where the work vehicle 100 performs tasked travel (e.g., at a position within 10 km of the work vehicle 100). The reference station 60 generates a correction signal of, for example, an RTCM format based on the satellite signals received from the plurality of GNSS satellites 50, and transmits the correction signal to the GNSS unit 110. The RTK receiver 112, which includes an antenna and a modem, receives the correction signal transmitted from the reference station 60. Based on the correction signal, the processing circuit 116 of the GNSS unit 110 corrects the results of the positioning performed by use of the GNSS receiver 111. Use of the RTK-GNSS enables positioning with an accuracy on the order of several centimeters of errors, for example. Positional data including latitude, longitude, and altitude information is acquired through the highly accurate positioning by the RTK-GNSS. The GNSS unit 110 calculates the position of the work vehicle 100 as frequently as, for example, one to ten times per second.

Note that the positioning method is not limited to being performed by use of an RTK-GNSS; any arbitrary positioning method (e.g., an interferometric positioning method or a relative positioning method) that provides positional data with the necessary accuracy can be used. For example, positioning may be performed by utilizing a VRS (Virtual Reference Station) or a DGPS (Differential Global Positioning System). In the case where positional data with the necessary accuracy can be obtained without the use of the correction signal transmitted from the reference station 60, positional data may be generated without using the correction signal. In that case, the GNSS unit 110 does not need to include the RTK receiver 112.

Even in the case where the RTK-GNSS is used, at a site where the correction signal from the reference station 60 cannot be acquired (e.g., on a road far from the field), the position of the work vehicle 100 is estimated by another method with no use of the signal from the RTK receiver 112. For example, the position of the work vehicle 100 may be estimated by matching the data output from the LiDAR sensor 140 and/or the cameras 120 against a highly accurate environment map.

The GNSS unit 110 according to the present example embodiment further includes the IMU 115. The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the GNSS unit 110.

The cameras 120 are imagers that image the environment around the work vehicle 100. Each of the cameras 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the environment around the work vehicle 100, and generate image data (e.g., motion picture data). The cameras 120 are able to capture motion pictures at a frame rate of 3 frames/second (fps: frames per second) or greater, for example. The images generated by the cameras 120 may be usable by a remote supervisor to check the environment around the work vehicle 100 with the terminal device 400, for example. The images generated by the cameras 120 may also be used for the purpose of positioning and/or detection of obstacles. As shown in FIG. 2, the plurality of cameras 120 may be provided at different positions on the work vehicle 100, or a single camera 120 may be provided. A visible camera(s) to generate visible light images and an infrared camera(s) to generate infrared images may be separately provided. Both of a visible camera(s) and an infrared camera(s) may be provided as cameras to generate images for monitoring purposes. The infrared camera(s) may also be used for detection of obstacles at nighttime.

The obstacle sensors 130 detect objects existing around the work vehicle 100. Each of the obstacle sensors 130 may include a laser scanner or an ultrasonic sonar, for example. When an object exists at a position within a predetermined distance from one of the obstacle sensors 130, the obstacle sensor 130 outputs a signal indicating the presence of the obstacle. The plurality of obstacle sensors 130 may be provided at different positions on the work vehicle 100. For example, a plurality of laser scanners and a plurality of ultrasonic sonars may be disposed at different positions on the work vehicle 100. Providing such a great number of obstacle sensors 130 can reduce blind spots in monitoring obstacles around the work vehicle 100.

The steering wheel sensor 152 measures the angle of rotation of the steering wheel of the work vehicle 100. The angle-of-turn sensor 154 measures the angle of turn of the front wheels 104F, which are the steered wheels. Measurement values by the steering wheel sensor 152 and the angle-of-turn sensor 154 are used for steering control by the controller 180.

The axle sensor 156 measures the rotational speed, i.e., the number of revolutions per unit time, of an axle that is connected to the wheels 104. The axle sensor 156 may be a sensor including a magnetoresistive element (MR), a Hall generator, or an electromagnetic pickup, for example. The axle sensor 156 outputs a numerical value indicating the number of revolutions per minute (unit: rpm) of the axle, for example. The axle sensor 156 is used to measure the speed of the work vehicle 100.

The drive device 240 includes various types of devices required to cause the work vehicle 100 to travel and to drive the implement 300, for example, the prime mover 102, the transmission 103, the steering device 106, the linkage device 108 and the like described above. The prime mover 102 may include an internal combustion engine such as, for example, a diesel engine. The drive device 240 may include an electric motor for traction instead of, or in addition to, the internal combustion engine.

The buzzer 220 is an audio output device to present an alarm sound to alert the user of an abnormality. For example, the buzzer 220 may present an alarm sound when an obstacle is detected during self-driving. The buzzer 220 is controlled by the controller 180.

The processor 161 may be a microprocessor or microcontroller. The processor 161 may be configured or programmed to process sensor data output from sensors, such as the cameras 120, the obstacle sensors 130 and the LiDAR sensor 140. For example, the processor 161 may be configured or programmed to detect objects around the work vehicle 100 based on data output from the cameras 120, the obstacle sensors 130 and the LiDAR sensor 140.

The storage device 170 includes one or more storage mediums such as a flash memory or a magnetic disc. The storage device 170 stores various data that is generated by the GNSS unit 110, the cameras 120, the obstacle sensors 130, the LiDAR sensor 140, the sensors 150, and the controller 180. The data that is stored by the storage device 170 may include map data on the environment where the work vehicle 100 travels (environment map) and data on a target path for self-driving. The environment map includes information on a plurality of fields where the work vehicle 100 performs agricultural work and roads around the fields. The environment map and the target path may be generated by a processor in the management device 600. The controller 180 may be configured or programmed to perform a function of generating or editing an environment map and a target path. The controller 180 can edit the environment map and the target path, acquired from the management device 600, in accordance with the environment where the work vehicle 100 travels. The storage device 170 also stores data on a work plan received by the communication device 190 from the management device 600.

The storage device 170 also stores a computer program(s) to cause the processor 161 and each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 includes the plurality of ECUs. The plurality of ECUs include, for example, the ECU 181 for speed control, the ECU 182 for steering control, the ECU 183 for implement control, the ECU 184 for self-driving control, and the ECU 185 for path generation.

The ECU 181 controls the prime mover 102, the transmission 103 and brakes included in the drive device 240, thus controlling the speed of the work vehicle 100.

The ECU 182 controls the hydraulic device or the electric motor included in the steering device 106 based on a measurement value of the steering wheel sensor 152, thus controlling the steering of the work vehicle 100.

In order to cause the implement 300 to perform a desired operation, the ECU 183 controls the operations of the three-point link, the PTO shaft and the like that are included in the linkage device 108. Also, the ECU 183 generates a signal to control the operation of the implement 300, and transmits this signal from the communication device 190 to the implement 300.

Based on data output from the GNSS unit 110, the cameras 120, the obstacle sensors 130, the LiDAR sensor 140, the sensors 150 and the processor 161, the ECU 184 performs computation and control for achieving self-driving. For example, the ECU 184 specifies the position of the work vehicle 100 based on the data output from at least one of the GNSS unit 110, the cameras 120 and the LiDAR sensor 140. Inside the field, the ECU 184 may determine the position of the work vehicle 100 based only on the data output from the GNSS unit 110. The ECU 184 may estimate or correct the position of the work vehicle 100 based on the data acquired by the cameras 120 and/or the LiDAR sensor 140. Use of the data acquired by the cameras 120 and/or the LiDAR sensor 140 allows the accuracy of the positioning to be further improved. Outside the field, the ECU 184 estimates the position of the work vehicle 100 by use of the data output from the LiDAR sensor 140 and/or the cameras 120. For example, the ECU 184 may estimate the position of the work vehicle 100 by matching the data output from the LiDAR sensor 140 and/or the cameras 120 against the environment map. During self-driving, the ECU 184 performs computation necessary for the work vehicle 100 to travel along a target path, based on the estimated position of the work vehicle 100. The ECU 184 sends the ECU 181 a command to change the speed, and sends the ECU 182 a command to change the steering angle. In response to the command to change the speed, the ECU 181 controls the prime mover 102, the transmission 103 or the brakes to change the speed of the work vehicle 100. In response to the command to change the steering angle, the ECU 182 controls the steering device 106 to change the steering angle.

The ECU 185 can determine a destination of the work vehicle 100 based on the work plan stored in the storage device 170, and determine a target path from a beginning point to a target point of the movement of the work vehicle 100. The ECU 185 may perform the process of detecting objects around the work vehicle 100 based on the data output from the cameras 120, the obstacle sensors 130 and the LiDAR sensor 140.

Through the actions of these ECUs, the controller 180 realizes self-driving. During self-driving, the controller 180 is configured or programmed to control the drive device 240 based on the measured or estimated position of the work vehicle 100 and on the target path. As a result, the controller 180 can cause the work vehicle 100 to travel along the target path.

The plurality of ECUs included in the controller 180 can communicate with each other in accordance with a vehicle bus standard such as, for example, a CAN (Controller Area Network). Instead of the CAN, faster communication methods such as Automotive Ethernet (registered trademark) may be used. Although the ECUs 181 to 185 are illustrated as individual blocks in FIG. 3, the function of each of the ECU 181 to 185 may be implemented by a plurality of ECUs. Alternatively, an onboard computer that integrates the functions of at least some of the ECUs 181 to 185 may be provided. The controller 180 may include ECUs other than the ECUs 181 to 185, and any number of ECUs may be provided in accordance with functionality. Each ECU includes a processing circuit including one or more processors. The controller 180 may include the processor 161. The processor 161 may be integrated with any of the ECUs included in the controller 180.

The communication device 190 is a device including a circuit communicating with the implement 300, the terminal device 400 and the management device 600. The communication device 190 includes circuitry to perform exchanges of signals complying with an ISOBUS standard such as ISOBUS-TIM, for example, between itself and the communication device 390 of the implement 300. This allows the implement 300 to perform a desired operation, or allows information to be acquired from the implement 300. The communication device 190 may further include an antenna and a communication circuit to exchange signals via the network 80 with communication devices of the terminal device 400 and the management device 600. The network 80 may include a 3G, 4G, 5G, or any other cellular mobile communications network and the Internet, for example. The communication device 190 may have a function of communicating with a mobile terminal that is usable by a supervisor who is situated near the work vehicle 100. With such a mobile terminal, communication may be performed based on any arbitrary wireless communication standard, e. g., Wi-Fi (registered trademark), 3G, 4G, 5G or any other cellular mobile communication standard, or Bluetooth (registered trademark).

The operational terminal 200 is a terminal for the user to perform a manipulation related to the travel of the work vehicle 100 and the operation of the implement 300, and is also referred to as a virtual terminal (VT). The operational terminal 200 may include a display device such as a touch screen panel, and/or one or more buttons. The display device may be a display such as a liquid crystal display or an organic light-emitting diode (OLED) display, for example. By manipulating the operational terminal 200, the user can perform various manipulations, such as, for example, switching ON/OFF the self-driving mode, recording or editing an environment map, setting a target path, and switching ON/OFF the implement 300. At least a portion of these manipulations may also be realized by manipulating the operation switches 210. The operational terminal 200 may be configured so as to be detachable from the work vehicle 100. A user who is at a remote place from the work vehicle 100 may manipulate the detached operational terminal 200 to control the operation of the work vehicle 100. Instead of the operational terminal 200, the user may manipulate a computer on which necessary application software is installed, for example, the terminal device 400, to control the operation of the work vehicle 100.

FIG. 5 is a diagram showing an example of the operational terminal 200 and an example of the operation switches 210 both provided in the cabin 105. In the cabin 105, the operation switches 210, including a plurality of switches that are manipulable to the user, are disposed. The operation switches 210 may include, for example, a switch to select the gear shift as to a main gear shift or a range gear shift, a switch to switch between a self-driving mode and a manual driving mode, a switch to switch between forward travel and backward travel, a switch to raise or lower the implement 300, and the like. In the case where the work vehicle 100 only performs unmanned driving and lacks human driving functionality, the work vehicle 100 does not need to include the operation switches 210.

The drive device 340 in the implement 300 shown in FIG. 3 performs operations necessary for the implement 300 to perform predetermined work. The drive device 340 includes a device suitable for uses of the implement 300, for example, a hydraulic device, an electric motor, a pump or the like. The controller 380 is configured or programmed to control the operation of the drive device 340. In response to a signal that is transmitted from the work vehicle 100 via the communication device 390, the controller 380 causes the drive device 340 to perform various operations. Moreover, a signal that is in accordance with the state of the implement 300 can be transmitted from the communication device 390 to the work vehicle 100.

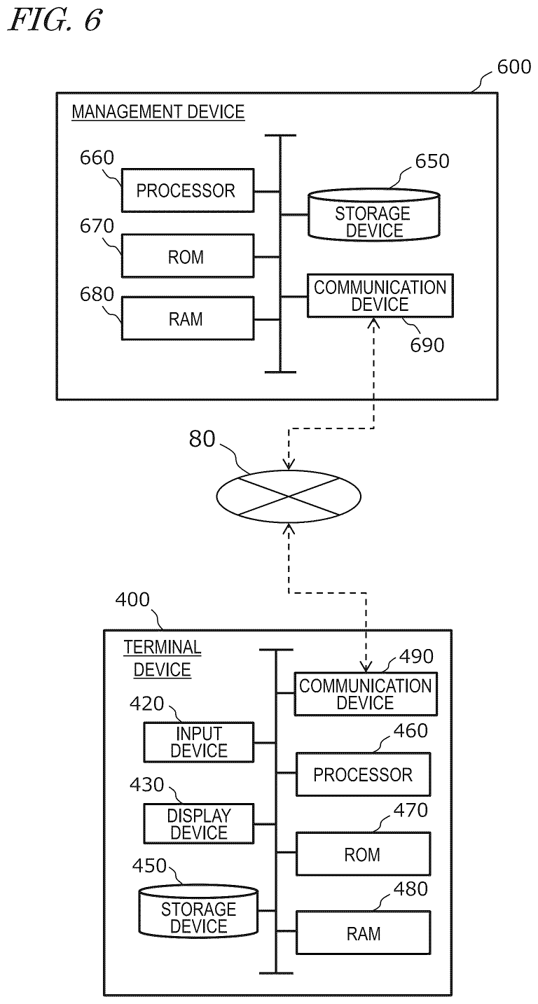

Now, a configuration of the management device 600 and the terminal device 400 will be described with reference to FIG. 6. FIG. 6 is a block diagram showing an example of schematic hardware configuration of the management device 600 and the terminal device 400.

The management device 600 includes a storage device 650, a processor 660, a ROM (Read Only Memory) 670, a RAM (Random Access Memory) 680, and a communication device 690. These component elements are communicably connected to each other via a bus. The management device 600 may be configured or programmed to function as a cloud server to manage the schedule of the agricultural work to be performed by the work vehicle 100 in a field and support agriculture by use of the data managed by the management device 600 itself. The user can input information necessary to create a work plan by use of the terminal device 400 and upload the information to the management device 600 via the network 80. The management device 600 can create a schedule of agricultural work, that is, a work plan based on the information. The management device 600 can further generate or edit an environment map. The environment map may be distributed from a computer external to the management device 600.

The communication device 690 is a communication module to communicate with the work vehicle 100 and the terminal device 400 via the network 80. The communication device 690 can perform wired communication in compliance with communication standards such as, for example, IEEE1394 (registered trademark) or Ethernet (registered trademark). The communication device 690 may perform wireless communication in compliance with Bluetooth (registered trademark) or Wi-Fi, or cellular mobile communication based on 3G, 4G, 5G or any other cellular mobile communication standard.

The processor 660 may be, for example, a semiconductor integrated circuit including a central processor (CPU). The processor 660 may be realized by a microprocessor or a microcontroller. Alternatively, the processor 660 may be realized by an FPGA (Field Programmable Gate Array), a GPU (Graphics Processor), an ASIC (Application Specific Integrated Circuit) or an ASSP (Application Specific Standard Product) each including a CPU, or a combination of two or more selected from these circuits. The processor 660 consecutively executes a computer program, describing commands to execute at least one process, stored in the ROM 670 and thus realizes a desired process.

The ROM 670 is, for example, a writable memory (e.g., PROM), a rewritable memory (e.g., flash memory) or a memory which can only be read from but cannot be written to. The ROM 670 stores a program to control operations of the processor 660. The ROM 670 does not need to be a single storage medium, and may be an assembly of a plurality of storage mediums. A portion of the assembly of the plurality of storage memories may be a detachable memory.

The RAM 680 provides a work area in which the control program stored in the ROM 670 is once developed at the time of boot. The RAM 680 does not need to be a single storage medium, and may be an assembly of a plurality of storage mediums.

The storage device 650 mainly functions as a storage for a database. The storage device 650 may be, for example, a magnetic storage device or a semiconductor storage device. An example of the magnetic storage device is a hard disc drive (HDD). An example of the semiconductor storage device is a solid state drive (SSD). The storage device 650 may be a device independent from the management device 600. For example, the storage device 650 may be a storage device connected to the management device 600 via the network 80, for example, a cloud storage.

The terminal device 400 includes an input device 420, a display device 430, a storage device 450, a processor 460, a ROM 470, a RAM 480, and a communication device 490. These component elements are communicably connected to each other via a bus. The input device 420 is a device to convert an instruction from the user into data and input the data to a computer. The input device 420 may be, for example, a keyboard, a mouse or a touch panel. The display device 430 may be, for example, a liquid crystal display or an organic EL display. The processor 460, the ROM 470, the RAM 480, the storage device 450 and the communication device 490 are substantially the same as the corresponding component elements described above regarding the example of the hardware configuration of the management device 600, and will not be described in repetition.

Now, an operation of the work vehicle 100, the terminal device 400 and the management device 600 will be described.

First, an example operation of self-traveling of the work vehicle 100 will be described. The work vehicle 100 according to the present example embodiment can automatically travel both inside and outside a field. Inside the field, the work vehicle 100 drives the implement 300 to perform predetermined agricultural work while traveling along a preset target path. When detecting an obstacle while traveling inside the field, the work vehicle 100 halts traveling and performs operations of presenting an alarm sound from the buzzer 220, transmitting an alert signal to the terminal device 400 and the like. Inside the field, the positioning of the work vehicle 100 is performed based mainly on data output from the GNSS unit 110. Meanwhile, outside the field, the work vehicle 100 automatically travels along a target path set for an agricultural road or a general road outside the field. While traveling outside the field, the work vehicle 100 travels with the effective use of data acquired by the cameras 120 and/or the LiDAR sensor 140. When an obstacle is detected outside the field, the work vehicle 100 avoids the obstacle or halts at the point. Outside the field, the position of the work vehicle 100 is estimated based on data output from the LiDAR sensor 140 and/or the cameras 120 in addition to positioning data output from the GNSS unit 110.

Hereinafter, an example of the operation performed when the work vehicle 100 performs self-traveling in the field is described.

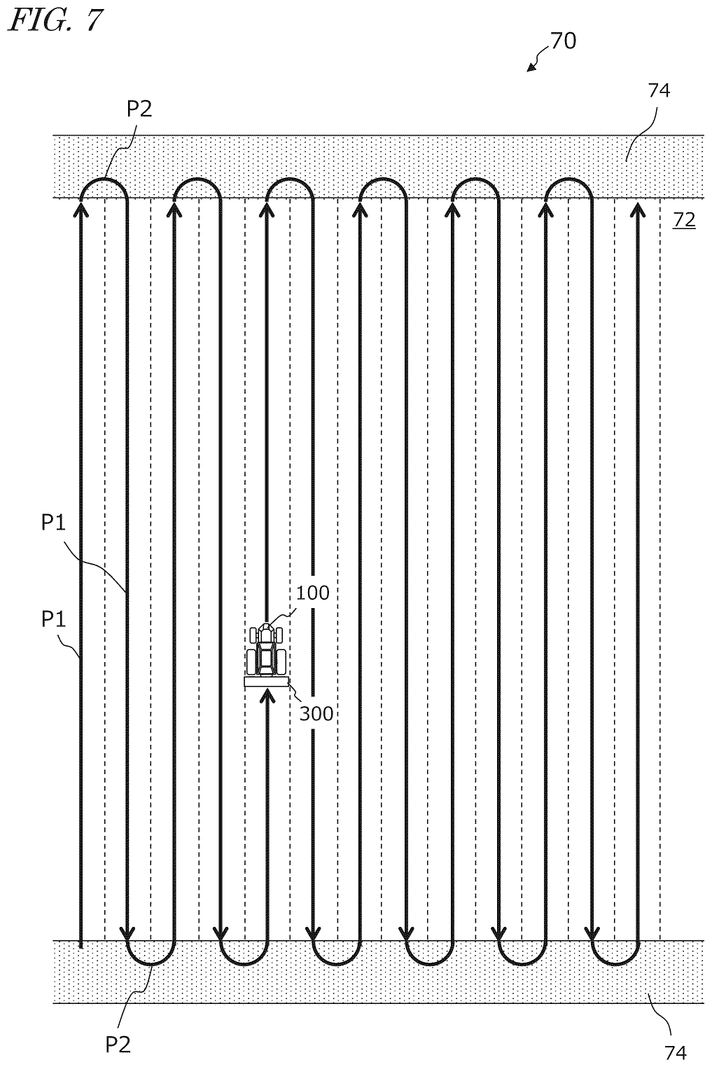

FIG. 7 is a diagram schematically showing an example of the work vehicle 100 automatically traveling along a target path in a field. In this example, the field 70 includes a work area 72, in which the work vehicle 100 performs work by using the implement 300, and headlands 74, which are located near outer edges of the field 70. The user may previously specify which regions of the field 70 on the map would correspond to the work area 72 and the headlands 74. The target path in this example includes a plurality of main paths P1 parallel to each other and a plurality of turning paths P2 interconnecting the plurality of main paths P1. The main paths Pl are located in the work area 72, whereas the turning paths P2 are located in the headlands 74. Although each of the main paths P1 in FIG. 7 is illustrated as a linear path, each main path P1 may also include a curved portion(s). Broken lines in FIG. 7 depict the working breadth of the implement 300. The working breadth is previously set and recorded in the storage device 170. The working breadth may be set and recorded by the user manipulating the operational terminal 200 or the terminal device 400. Alternatively, the working breadth may be automatically recognized and recorded when the implement 300 is connected to the work vehicle 100. The interval between the plurality of main paths P1 may be set so as to be matched to the working breadth. The target path may be generated based on the manipulation made by the user, before self-driving is begun. The target path may be generated so as to cover the entire work area 72 in the field 70, for example. Along the target path shown in FIG. 7, the work vehicle 100 automatically travels while repeating a reciprocating motion from a beginning point of work to an ending point of work. Note that the target path shown in FIG. 7 is merely an example, and the target path may be arbitrarily determined.

Now, an example control by the controller 180 during self-driving inside the field will be described.

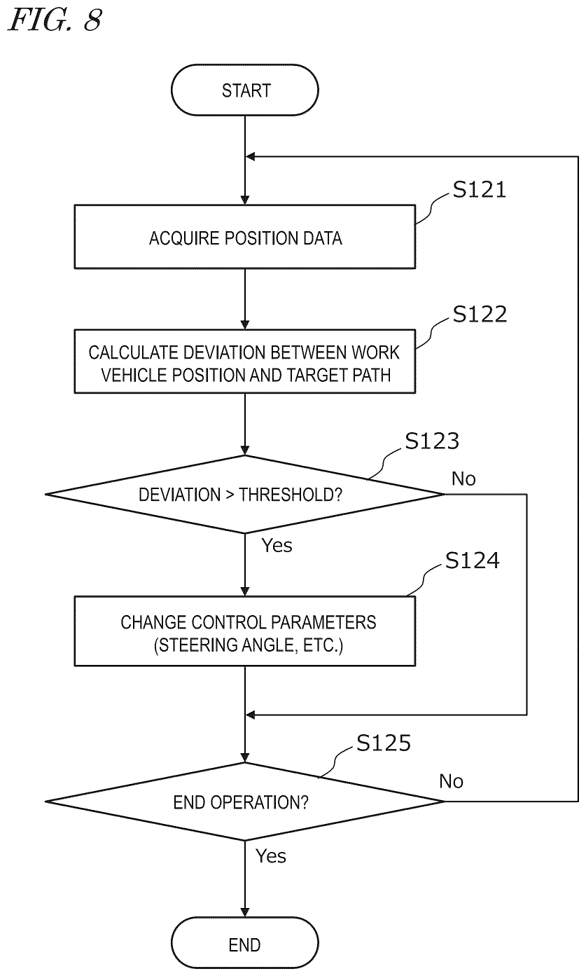

FIG. 8 is a flowchart showing an example operation of steering control to be performed by the controller 180 during self-driving. During travel of the work vehicle 100, the controller 180 performs automatic steering by performing the operation from steps S121 to S125 shown in FIG. 8. The speed of the work vehicle 100 will be maintained at a previously-set speed, for example. First, during travel of the work vehicle 100, the controller 180 acquires data representing the position of the work vehicle 100 that is generated by the GNSS unit 110 (step S121). Next, the controller 180 calculates a deviation between the position of the work vehicle 100 and the target path (step S122). The deviation represents the distance between the position of the work vehicle 100 and the target path at that moment. The controller 180 determines whether the calculated deviation in position exceeds the previously-set threshold or not (step S123). If the deviation exceeds the threshold, the controller 180 changes a control parameter of the steering device included in the drive device 240 so as to reduce the deviation, thus changing the steering angle (step S124). If the deviation does not exceed the threshold at step S123, the operation of step S124 is omitted. At the following step S125, the controller 180 determines whether a command to end the operation has been received or not. The command to end the operation may be given when the user has instructed that self-driving be suspended through remote operations, or when the work vehicle 100 has arrived at the destination, for example. If the command to end the operation has not been given, the control returns to step S121 and the controller 180 performs substantially the same operation based on a newly measured position of the work vehicle 100. The controller 180 repeats the operation from steps S121 to S125 until a command to end the operation is given. The aforementioned operation is executed by the ECUs 182 and 184 in the controller 180.

In the example shown in FIG. 8, the controller 180 controls the drive device 240 based only on the deviation between the position of the work vehicle 100 as identified by the GNSS unit 110 and the target path. Alternatively, a deviation in terms of directions may further be considered in the control. For example, when a directional deviation exceeds a previously-set threshold, where the directional deviation is an angle difference between the orientation of the work vehicle 100 as identified by the GNSS unit 110 and the direction of the target path, the controller 180 may change the control parameter of the steering device of the drive device 240 (e.g., steering angle) in accordance with the deviation.

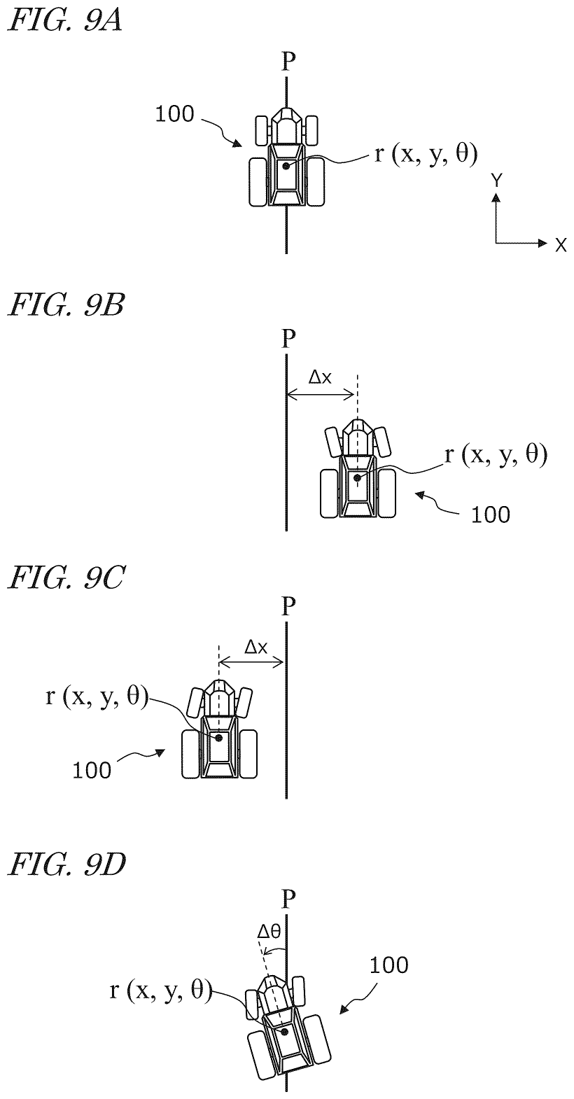

Hereinafter, with reference to FIGS. 9A to 9D, an example of steering control by the controller 180 will be described more specifically.

FIG. 9A is a diagram showing an example of the work vehicle 100 traveling along a target path P. FIG. 9B is a diagram showing an example of the work vehicle 100 at a position which is shifted rightward from the target path P. FIG. 9C is a diagram showing an example of the work vehicle 100 at a position which is shifted leftward from the target path P. FIG. 9D is a diagram showing an example of the work vehicle 100 oriented in an inclined direction with respect to the target path P. In these figures, the pose, i.e., the position and orientation, of the work vehicle 100 as measured by the GNSS unit 110 is expressed as r (x, y, θ). Herein, (x, y) are coordinates representing the position of a reference point on the work vehicle 100 in an XY coordinate system, which is a two-dimensional coordinate system fixed to the globe. In the examples shown in FIGS. 9A to 9D, the reference point on the work vehicle 100 is at a position, on the cabin, where a GNSS antenna is disposed, but the reference point may be at any arbitrary position. θ is an angle representing the measured orientation of the work vehicle 100. Although the target path P is shown parallel to the Y axis in the examples illustrated in these figures, the target path P may not necessarily be parallel to the Y axis, in general.

As shown in FIG. 9A, in the case where the position and orientation of the work vehicle 100 are not deviated from the target path P, the controller 180 maintains the steering angle and speed of the work vehicle 100 without changing them.

As shown in FIG. 9B, when the position of the work vehicle 100 is shifted rightward from the target path P, the controller 180 changes the steering angle so that the traveling direction of the work vehicle 100 will be inclined leftward, thus bringing the work vehicle 100 closer to the path P. At this point, not only the steering angle but also the speed may be changed. The magnitude of the steering angle may be adjusted in accordance with the magnitude of a positional deviation Δx, for example.

As shown in FIG. 9C, when the position of the work vehicle 100 is shifted leftward from the target path P, the controller 180 changes the steering angle so that the traveling direction of the work vehicle 100 will be inclined rightward, thus bringing the work vehicle 100 closer to the path P. In this case, too, not only the steering angle but also the speed may be changed. The amount of change of the steering angle may be adjusted in accordance with the magnitude of the positional deviation Δx, for example.

As shown in FIG. 9D, in the case where the position of the work vehicle 100 is not considerably deviated from the target path P but its orientation is nonetheless different from the direction of the target path P, the controller 180 changes the steering angle so that the directional deviation Δθ will become smaller. In this case, too, not only the steering angle but also the speed may be changed. The magnitude of the steering angle may be adjusted in accordance with the magnitudes of the positional deviation Δx and the directional deviation Δθ, for example. For instance, the amount of change of the steering angle (which is in accordance with the directional deviation Δθ) may be increased as the absolute value of the positional deviation Δx decreases. When the positional deviation Δx has a large absolute value, the steering angle will be changed greatly in order for the work vehicle 100 to return to the path P, so that the directional deviation Δθ will inevitably have a large absolute value. Conversely, when the positional deviation Δx has a small absolute value, the directional deviation Δθ needs to become closer to zero. Therefore, it may be advantageous to introduce a relatively large weight (i.e., control gain) for the directional deviation 40 in determining the steering angle.

For the steering control and speed control of the work vehicle 100, control techniques such as PID control or MPC (Model Predictive Control) may be applied. Applying these control techniques will make for smoothness of the control of bringing the work vehicle 100 closer to the target path P.

Note that, when an obstacle is detected by sensors such as the cameras 120, the obstacle sensors 130 and the LiDAR sensor 140 during travel, the controller 180 halts the work vehicle 100. At this point, the controller 180 may cause the buzzer 220 to present an alarm sound or may transmit an alert signal to the terminal device 400. In the case where the obstacle is avoidable, the controller 180 may control the drive device 240 such that the obstacle is avoided.

The work vehicle 100 according to the present example embodiment can perform self-traveling outside a field as well as inside the field. Outside the field, the processor 161 and/or the controller 180 is able to detect objects around the work vehicle 100 (e.g., another vehicle, a pedestrian, etc.) based on data output from sensors such as the cameras 120, the obstacle sensors 130 and the LiDAR sensor 140. Using the cameras 120 and the LiDAR sensor 140 enables detection of an object located at a relatively distant position from the work vehicle 100. The controller 180 performs speed control and steering control such that the work vehicle 100 avoids the detected object, thereby realizing self-traveling on a road outside the field.

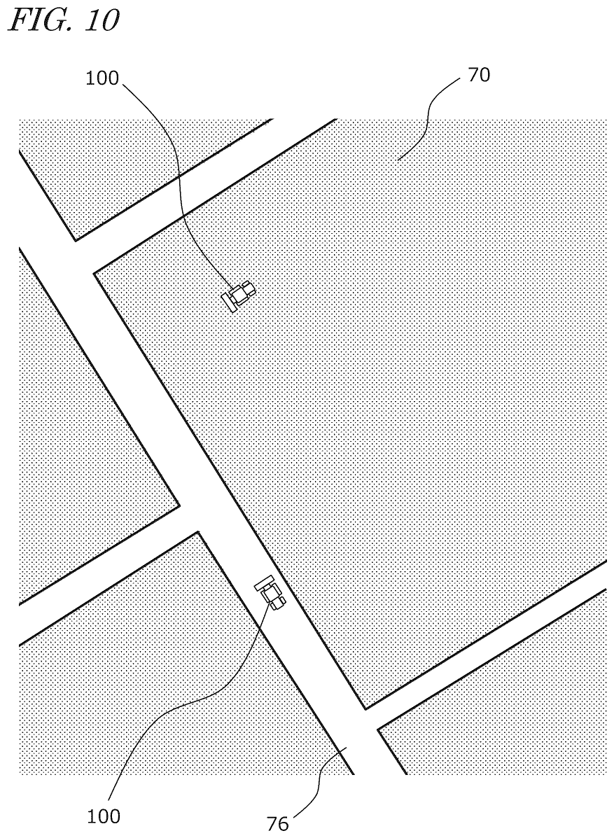

As described above, the work vehicle 100 according to the present example embodiment can automatically travel inside the field and outside the field in an unmanned manner. FIG. 10 is a diagram schematically showing an example of state where a plurality of the work vehicles 100 are performing self-traveling inside a field 70 and on a road 76 outside the field 70. In the storage device 170, an environment map of a region including a plurality of fields 70 and roads around the fields 70, and a target path, are recorded. The environment map and the target path may be generated by the management device 600 or the ECU 185. In the case of traveling on a road, the work vehicle 100 travels along the target path while sensing the surroundings thereof by use of the sensors such as the cameras 120, the obstacle sensors 130 and the LiDAR sensor 140, with the implement 300 being raised.

Next, the process of setting the alert zone according to the implement 300 connected with the work vehicle 100 is described.

In some cases, it is desirable that humans do not enter an area near the implement 300 that is performing work in a field. Therefore, one possible solution is to set an alert zone around the implement 300. The alert zone refers to an area in which, for example, if it is determined that a human is present in that area, at least one of issuance of a warning, stoppage of work of the implement 300, and slowdown of the work of the implement 300 is performed.

First, the sensing region, the search region, and the alert zone are separately described.

As previously described, sensors, such as the cameras 120, the obstacle sensors 130 and the LiDAR sensor 140, sense the environment around the work vehicle 100 and output sensor data. The work vehicle 100 of the present example embodiment includes a sensing system 10 (FIG. 3) configured to detect objects around the work vehicle 100 using the sensor data output from the sensors. The sensing system 10 includes the processor 161, the cameras 120, the obstacle sensors 130 and the LiDAR sensor 140.

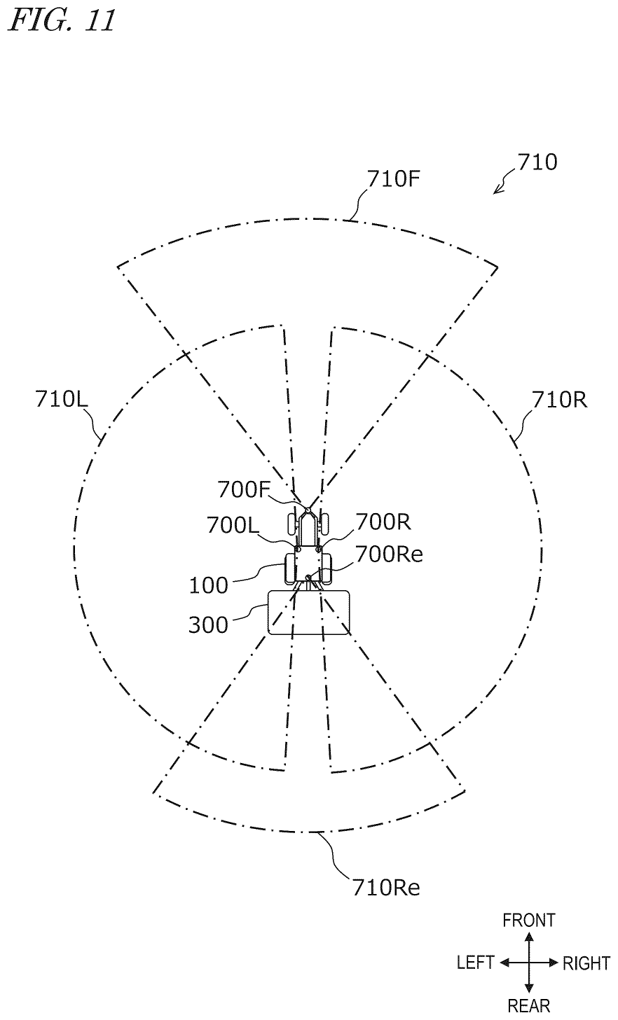

FIG. 11 is a diagram showing an example of a sensing region 710 sensed by the sensors.

The sensing region 710 includes a front sensing region 710F, a rear sensing region 710Re, a left lateral sensing region 710L, and a right lateral sensing region 710R. FIG. 11 shows the sensing regions as viewed in plan from a vertical direction while the work vehicle 100 is on horizontal ground.

In this example, as the sensors, the work vehicle 100 includes sensors 700F, 700Re, 700L, 700R. The sensor 700F is provided in the front-side portion of the work vehicle 100 to mainly sense part of the surrounding environment extending on the front side of the work vehicle 100. The sensor 700Re is provided in the rear-side portion of the work vehicle 100 to mainly sense part of the surrounding environment extending on the rear side of the work vehicle 100. The sensor 700L is provided in the left-side portion of the work vehicle 100 to mainly sense part of the surrounding environment extending on the left side of the work vehicle 100. The sensor 700R is provided in the right-side portion of the work vehicle 100 to mainly sense part of the surrounding environment extending on the right side of the work vehicle 100. The sensors 700Re, 700L, 700R can be provided in, for example, the cabin 105 of the work vehicle 100 (FIG. 2). The sensor 700Re may be provided in the implement 300.

In the present example embodiment, in the front-side portion of the work vehicle 100, a camera 120 and a LiDAR sensor 140 are provided as the sensor 700F. In the rear-side portion of the work vehicle 100, a camera 120 and a LiDAR sensor 140 are provided as the sensor 700Re. In the left-side portion of the work vehicle 100, a camera 120, an obstacle sensor 130, and a LiDAR sensor 140 are provided as the sensor 700L. In the right-side portion of the work vehicle 100, a camera 120, an obstacle sensor 130, and a LiDAR sensor 140 are provided as the sensor 700R. The sensors 700F and 700Re may include an obstacle sensor 130.

In the examples described below, for clearly describing the features, a region sensed by the LiDAR sensor 140 is described as the sensing region 710.

The LiDAR sensor 140 is capable of sequentially emitting pulses of a laser beam (hereinafter, abbreviated as “laser pulses”) while changing the direction of emission and measuring the distance to a point of reflection of each laser pulse based on the difference between the time of emission of each laser pulse and the time of reception of reflection of the laser pulse. The “point of reflection” can be an object in an environment around the work vehicle 100.

The LiDAR sensor 140 can measure the distance from the LiDAR sensor 140 to an object by an arbitrary method. Examples of the measurement method of the LiDAR sensor 140 include mechanical rotation, MEMS, and phased array type measurement methods. These measurement methods are different in the method of emitting laser pulses (the method of scanning). For example, the mechanical rotation type LiDAR sensor rotates a cylindrical head, which is for emitting laser pulses and detecting reflection of the laser pulses, to scan the surrounding environment in all directions, i.e., 360 degrees, around the axis of rotation. The MEMS type LiDAR sensor uses a MEMS mirror to oscillate the emission direction of laser pulses and scans the surrounding environment in a predetermined angular range centered on the oscillation axis. The phased array type LiDAR sensor controls the phase of light to oscillate the emission direction of the light and scans the surrounding environment in a predetermined angular range centered on the oscillation axis.

As previously described, the sensing region 710 includes the front sensing region 710F, the rear sensing region 710Re, the left lateral sensing region 710L, and the right lateral sensing region 710R. The front sensing region 710F is a region sensed by the LiDAR sensor 140 provided in the front-side portion of the work vehicle 100. The rear sensing region 710Re is a region sensed by the LiDAR sensor 140 provided in the rear-side portion of the work vehicle 100. The left lateral sensing region 710L is a region sensed by the LiDAR sensor 140 provided in the left-side portion of the work vehicle 100. The right lateral sensing region 710R is a region sensed by the LiDAR sensor 140 provided in the right-side portion of the work vehicle 100.

The processor 161 (FIG. 3) detects objects in the search regions around the work vehicle 100 based on the sensor data output from the LiDAR sensors 140. The search region refers to a portion of the sensing region 710 in which a search for objects is to be conducted. The search regions may be equal in size to, or may be smaller than, the sensing regions 710. The search region can also be referred to as Region of Interest (ROI).

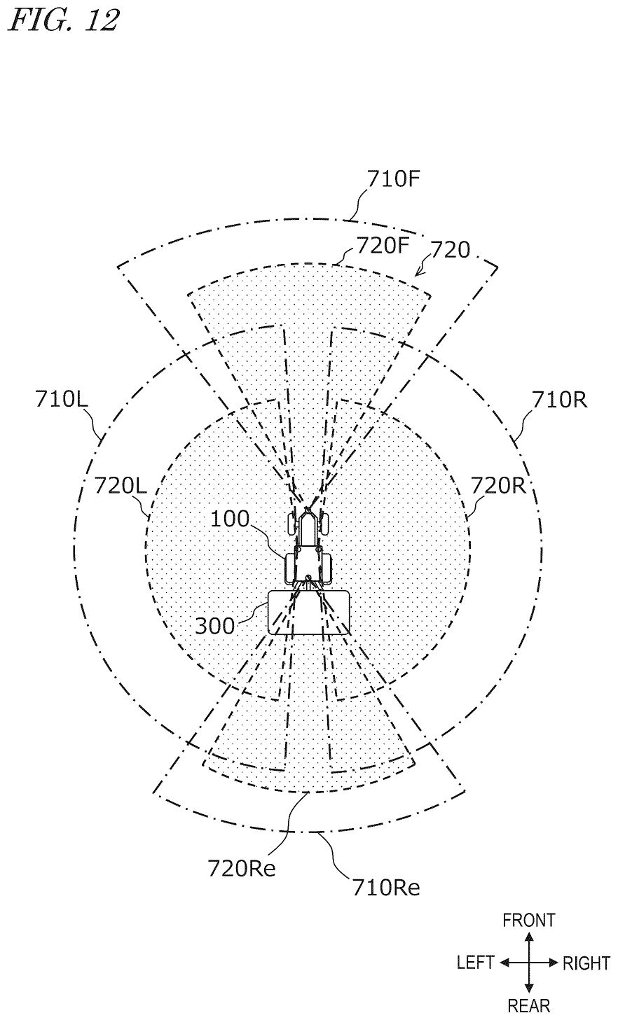

FIG. 12 shows the relationship between sensing regions 710 sensed by LiDAR sensors 140 and search regions 720 in which a search for objects is to be conducted. The shape, size, and position of the search regions can be realized by, for example, changing part of the three-dimensional point cloud data output by the LiDAR sensors 140 which is to be used in search for objects.

The three-dimensional point cloud data output by the LiDAR sensors 140 includes the information about the position of a plurality of points and the information such as the reception intensity of a photodetector (attribute information). The information about the position of a plurality of points is, for example, the information about the emission direction of laser pulses corresponding to the points and the distance between the LiDAR sensors and the points. For example, the information about the position of a plurality of points is the information about the coordinates of the points in a local coordinate system. The local coordinate system is a coordinate system that moves together with the work vehicle 100 and is also referred to as sensor coordinate system. The coordinates of each point can be calculated from the emission direction of laser pulses corresponding to the points and the distance between the LiDAR sensors and the points.

For example, the search region can be set based on the coordinates of each of the points. By selecting points located inside a desired shape in a local coordinate system as points which are to be used in search for objects, the search region of the desired shape can be set.

The search region 720 includes a front search region 720F, a rear search region 720Re, a left lateral search region 720L, and a right lateral search region 720R.

The search region 720F can be set by selecting points located inside a predetermined shape in a local coordinate system from a plurality of points indicated by the three-dimensional point cloud data output by the LiDAR sensor 140 provided in the front-side portion of the work vehicle 100. The search region 720Re can be set by selecting points located inside a predetermined shape in a local coordinate system from a plurality of points indicated by the three-dimensional point cloud data output by the LiDAR sensor 140 provided in the rear-side portion of the work vehicle 100.

The search region 720L can be set by selecting points located inside a predetermined shape in a local coordinate system from a plurality of points indicated by the three-dimensional point cloud data output by the LiDAR sensor 140 provided in the left-side portion of the work vehicle 100. The search region 720R can be set by selecting points located inside a predetermined shape in a local coordinate system from a plurality of points indicated by the three-dimensional point cloud data output by the LiDAR sensor 140 provided in the right-side portion of the work vehicle 100.

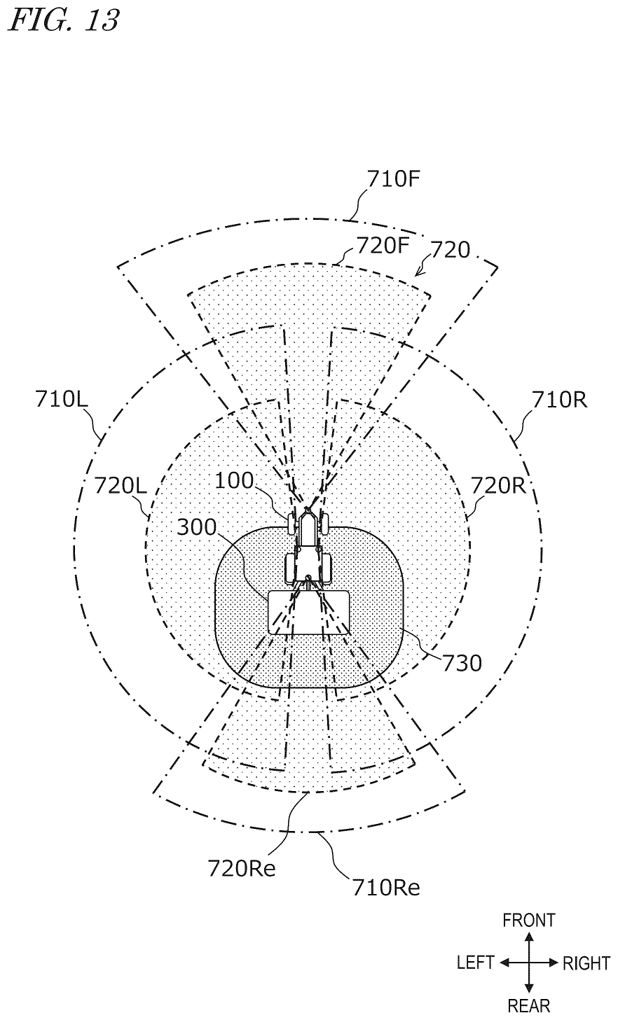

FIG. 13 is a diagram showing the relationship between the search regions 720 and the alert zone 730. The alert zone 730 can be set in a predetermined area within the search regions 720. The alert zone 730 can be set by selecting points located inside a predetermined shape in a local coordinate system from a plurality of points indicated by the three-dimensional point cloud data output by the LiDAR sensors 140. In the present example embodiment, the alert zone 730 is set around the implement 300 connected with the work vehicle 100. The control system 160 (FIG. 3) determines whether or not a human is present in the set alert zone 730. If the control system 160 determines that a human is present in the alert zone, the control system 160 is configured or programmed to control at least one of the following operations: issuance of a warning, stoppage of work of the implement 300, and slowdown of the work of the implement 300.

FIG. 13 shows the alert zone 730 as viewed in plan from a vertical direction while the work vehicle 100 and the implement 300 are on horizontal ground. In the present example embodiment, the size of the alert zone 730 as viewed in plan from a vertical direction is changed according to the implement 300 used.

Since the size and operation of the implement can vary among implements, varying the size of the alert zone 730 among the implements can be considered. Setting the size of the alert zone 730 for each of the implements using information inherent to each implement, such as the size of the implement, can be considered.

On the other hand, there are many implement manufacturers, and each manufacturer sells a variety of implements. A very large number of different models of implements have been in circulation in the market. For many models, the information about the size and other specifications is not disclosed by the manufacturers.

If the information necessary for setting the size of the alert zone 730, such as the size of the implement used, cannot be obtained, it will be difficult to set the size of the alert zone 730. Even when an implement is used of which the information necessary for setting the size of the alert zone 730 is not disclosed by the manufacturer, the capability of setting the size of the alert zone 730 is required.

In the agricultural management system 1 of the present example embodiment, implement information concerning a plurality of types of implements, which is provided by a plurality of users, is obtained, and the obtained implement information is accumulated in the server 600. The implement information corresponding to identification information of the implement 300 connected with the work vehicle 100 is retrieved from the server 600, and the size of the alert zone 730 is set based on the retrieved implement information.

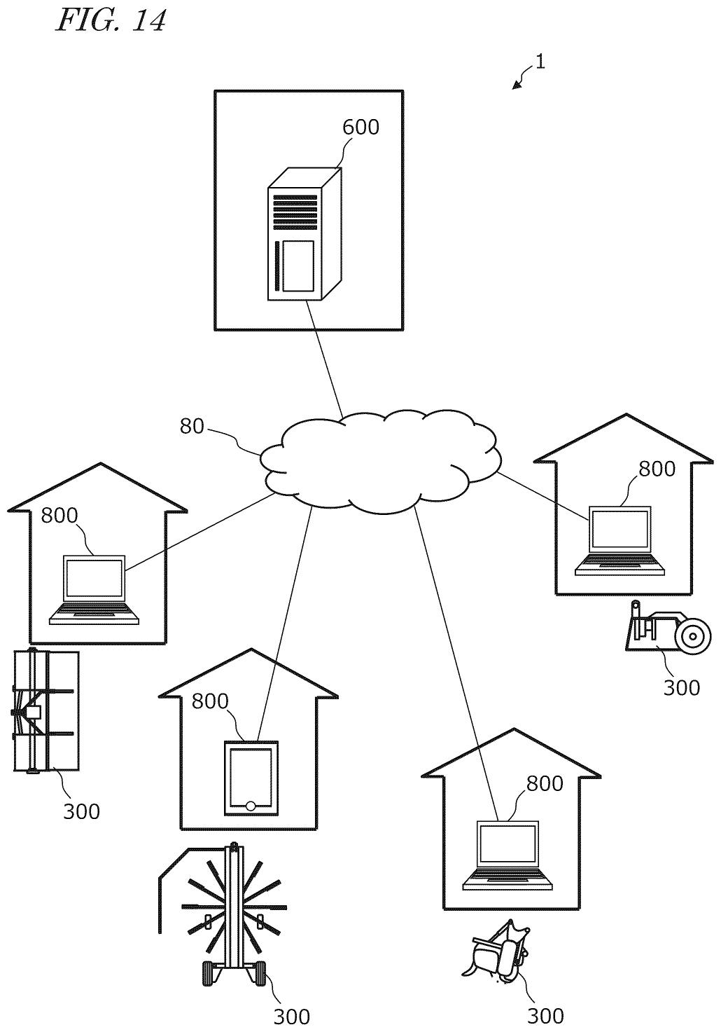

FIG. 14 is a diagram showing the agricultural management system 1 wherein implement information provided by a plurality of users is accumulated in the server 600. Each of the users can upload information concerning the implement owned and/or usable by the user to the server 600 using a terminal device 800. The terminal device 800 is a computer usable by the user. The terminal device 800 can be a stationary computer such as laptop computer or desktop PC (personal computer), or a mobile terminal such as smartphone or tablet computer.

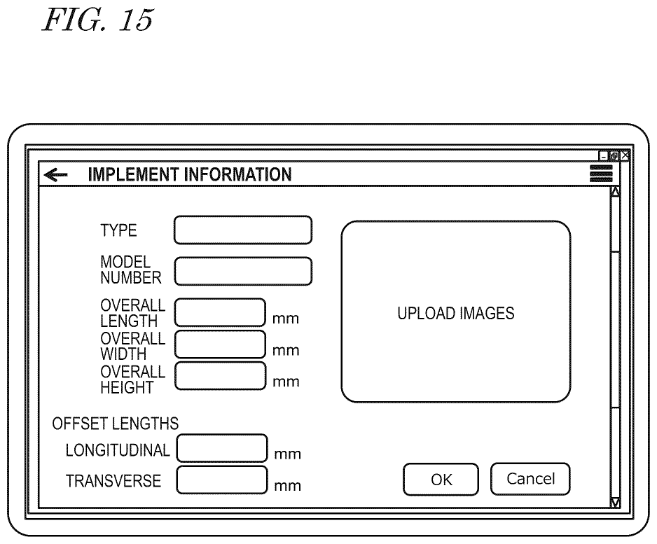

FIG. 15 is a diagram showing an example of an input window for implement information, which is displayed on the display of the terminal device 800.

In the example shown in FIG. 15, users input the type, model number, overall length, overall width, overall height, and offset lengths of the implement as the implement information. The users can also upload image data of the implement as the implement information.

Examples of the type of the implement include tiller, seeder, spreader, transplanter, mower, rake implement, baler, harvester, sprayer, and harrow. These implement types are merely exemplary, and the implement is not limited to these examples.

The model number is a number assigned by the manufacturer to each type of implement and can be formed by a combination of a plurality of arbitrary letters, such as numerical and alphabetical characters. The overall length is a dimension of the implement in the longitudinal direction. The overall width is a dimension of the implement in the transverse direction. The overall height is a dimension of the implement in the vertical direction.

The offset lengths refer to a deviation from the joint of the implement to which a linkage device is connected. The longitudinal offset length refers to a longitudinal length between the front end of the implement and the joint. The transverse offset length refers to a transverse length between the transverse center of the implement and the joint. The position of the joint, which serves as the reference point for the offset lengths, can be, for example, a position of the implement at which the PTO shaft is connected.

The information concerning the lengths of the implement can be obtained by, example, measuring the lengths of respective dimensions of the implement by users. The size information of the implement, which is used for setting the alert zone 730, does not need to be strictly accurate but may be approximate values. For example, a measurement error of about ±10% can be tolerated. Since the width of the alert zone 730 can be several meters, setting of the alert zone 730 is possible even if the size values are approximate values.

Users can upload the above-described implement information to the server 600 via the terminal device 800. The server 600 stores the implement information collected from a plurality of users.

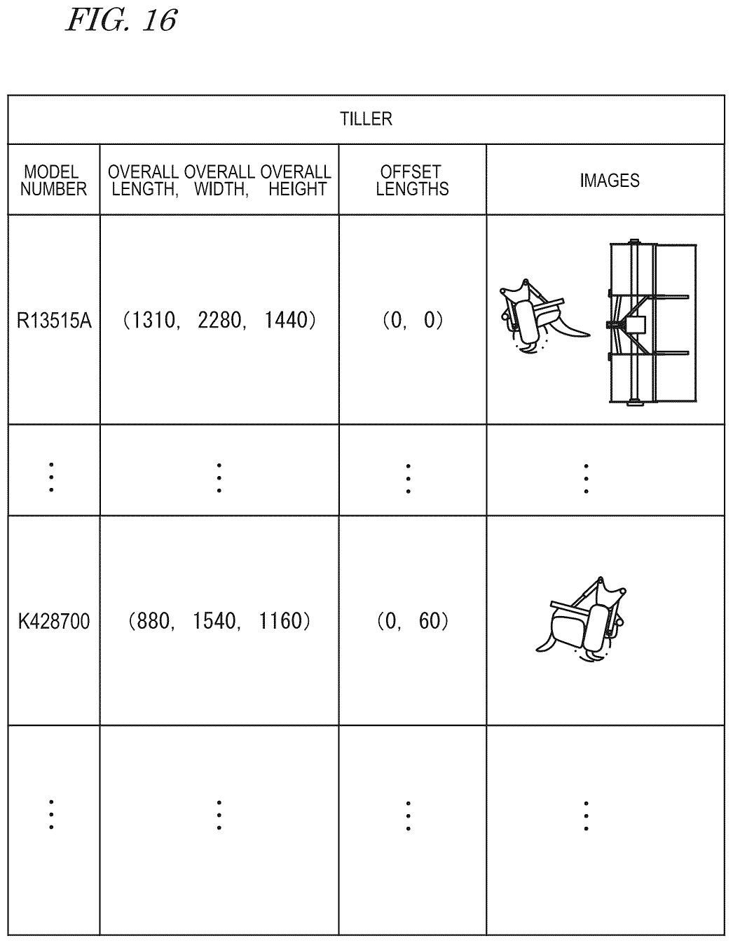

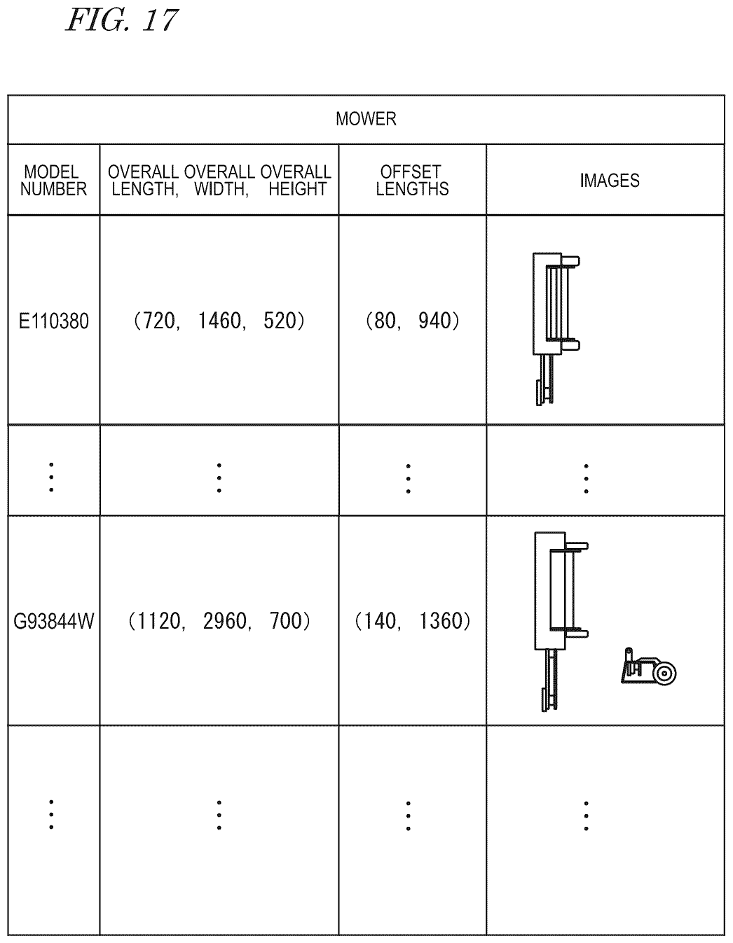

FIG. 16 and FIG. 17 are diagrams showing examples of the implement information stored in the server 600. The implement information collected from a plurality of users can be sorted by model numbers and stored in the server 600.

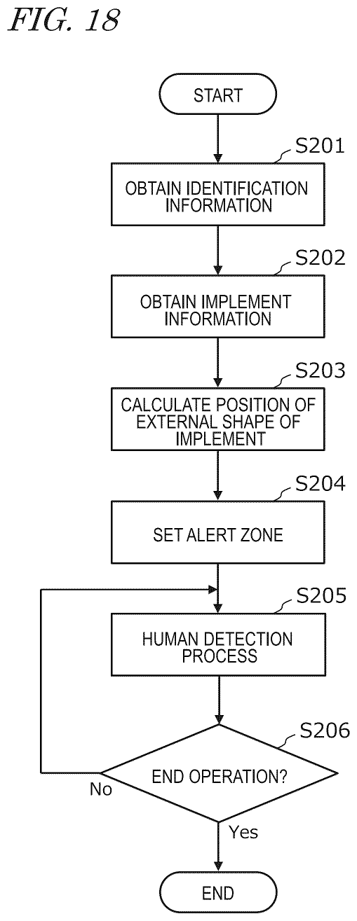

Next, the process of setting the alert zone 730 using the implement information stored in the server 600 is described. FIG. 18 is a flowchart showing an example of the process of setting the alert zone 730 using the implement information stored in the server 600.

First, identification information which identifies an implement 300 connected with the work vehicle 100 is obtained (step S201). The processor 161 of the work vehicle 100 obtains the identification information from the implement 300 connected with the work vehicle 100, for example. The identification information can be, for example, the model number of the implement 300.

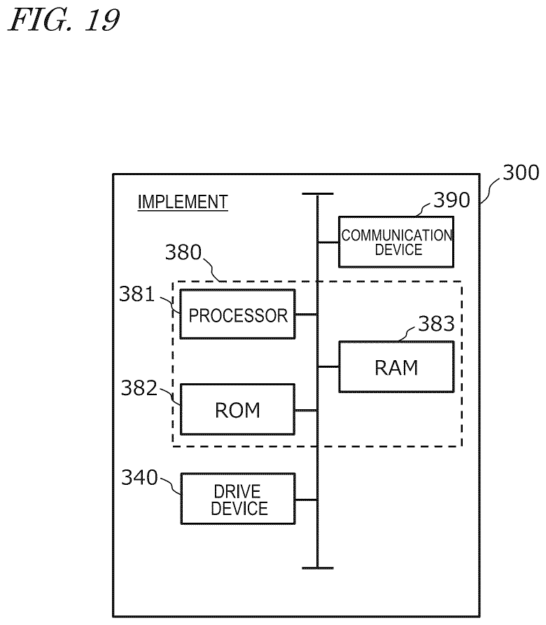

FIG. 19 is a block diagram showing an example of the hardware configuration of the implement 300. The implement 300 includes a controller 380, a communication device 390, and a drive device 340. These component elements are communicably connected to each other via a bus. The controller 380 includes a processor 381, a ROM 382, and a RAM 383.

The communication device 190 of the work vehicle 100 (FIG. 3) and the communication device 390 of the implement 300 perform data communication between the work vehicle 100 and the implement 300. For example, when communication is established in compliance with communication control standards such as ISOBUS based on ISO 11783, it is possible to communicate bidirectionally between the work vehicle 100 and the implement 300. If the work vehicle 100 and the implement 300 are compatible with a tractor-implement management (TIM) system such as ISOBUS-TIM, control by the work vehicle 100 over the implement 300 and control by the implement 300 over the work vehicle 100 are possible. These communications can be established by wired communication but may be established by wireless communication.

The identification information is stored in advance in a memory device in the implement 300, for example, in the ROM 382. As previously described, the work vehicle 100 and the implement 300 are capable of establishing communication in compliance with communication control standards such as ISOBUS.

When the implement 300 is connected with the work vehicle 100, the processor 381 retrieves the identification information from the ROM 382 and outputs the retrieved identification information to the work vehicle 100 via the communication device 390. The processor 161 of the work vehicle 100 outputs the received identification information to the server 600 via the communication device 190. The processor 161 requests the server 600 to send implement information corresponding to the identification information to the work vehicle 100.

The processor 660 of the server 600 retrieves implementation information corresponding to the model number indicated by the received identification information from the storage device 650 and sends the retrieved implementation information to the work vehicle 100 via the communication device 690. The communication device 190 of the work vehicle 100 receives the implement information sent from 600, and the processor 161 can obtain the implement information (step S202).

The implement information includes size information, such as the overall length, overall width, overall height, offset lengths of the implement 300. The processor 161 sets the size of the alert zone 730 using these pieces of the size information, for example.

The processor 161 calculates the position of at least a portion of the external shape of the implement 300 in a local coordinate system of the work vehicle 100 and the implement 300, which are connected with each other, based on the size information (step S203).

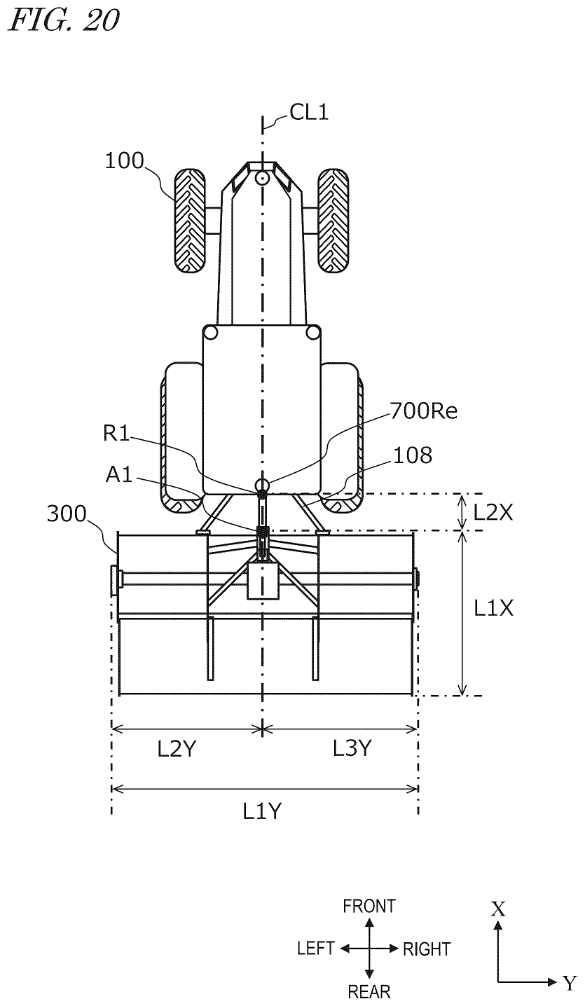

FIG. 20 is a diagram showing an example of the method of calculating the position of at least a portion of the external shape of the implement 300 in a local coordinate system. The processor 161 executes, for example, the operations described below to calculate the coordinates of at least a portion of the external shape of the implement 300.

In the local coordinate system of the present example embodiment, when the work vehicle 100 and the implement 300, which are connected with each other, are traveling in a straight line on a flat ground, the longitudinal direction of the vehicle is referred to as X direction, and the transverse direction of the vehicle is referred to as Y direction. The direction from rear to front is referred to as +X direction, and the direction from left to right is referred to as +Y direction. ISO 11783 defines the device geometry as follows: “In the X-axis, the normal travelling direction is specified as positive” and “In the Y-axis, the right side of the device with respect to the normal travelling direction is specified as positive”. Based on that definition of the device geometry, the X and Y directions in the local coordinate system of the present example embodiment are defined. The unit of the coordinate values of the local coordinate system is arbitrary, and herein we use “millimeter” as an example.

In a local coordinate system for the work vehicle 100 alone and in a local coordinate system for the implement 300 alone, the X and Y directions and the unit of coordinate values are defined in the same way as described above.

In the example shown in FIG. 20, a tiller, which is an example of the implement 300, is connected with the work vehicle 100. The overall length of the implement 300 is LIX, and the overall width of the implement 300 is L1Y. Both of the longitudinal and transverse offset lengths are zero.

The work vehicle 100 and the implement 300 are connected together using a linkage device 108. The reference point R1 in the local coordinate system can be set at an arbitrary position of the work vehicle 100. The coordinate values of the reference point R1 are stored in advance in the storage device 170 of the work vehicle 100. In the example shown in FIG. 20, the reference point R1 is set on the center line CL1 that extends in the longitudinal direction through the transverse center of the work vehicle 100. The Y coordinate of the reference point R1 is equal to the Y coordinate of the center line CL1. The X coordinate of the reference point R1 is set to the X coordinate of the joining position of the work vehicle 100 and the linkage device 108 (i.e. approximately the position of the front end of the linkage device 108). The PTO shaft extends backwards from the position in the rear part of the work vehicle 100 at which the center line CL1 passes.

The value of the longitudinal length L2X of the linkage device 108 is stored in advance in the storage device 170 of the work vehicle 100. The value of the length L2X may be input by the user using an input device 420, for example. The X coordinate of the rear end position A1 of the linkage device 108 is equal to the X coordinate of the front end of the implement 300.

In the example shown in FIG. 20, the offset lengths are zero. Therefore, the X coordinate of a rear-side position away from the reference point R1 by the length L2X is equal to the X-coordinate of the front end of the implement 300. The X coordinate of a rear-side position away from the reference point R1 by the sum of the length L1X and the length L2X is equal to the X coordinate of the rear end of the implement 300.

The Y coordinate of a position on the transverse center of the implement is equal to the Y coordinate of the center line CL1. The length L2Y between the center line CL1 and the left end of the implement 300 is ½ of the overall width L1Y. The length L3Y between the center line CL1 and the right end of the implement 300 is ½ of the overall width L1Y. The Y coordinate of a left-side position away from the center line CL1 by the length L2Y is equal to the Y coordinate of the left end of the implement 300. The Y coordinate of a right-side position away from the center line CL1 by the length L3Y is equal to the Y coordinate of the right end of the implement 300.

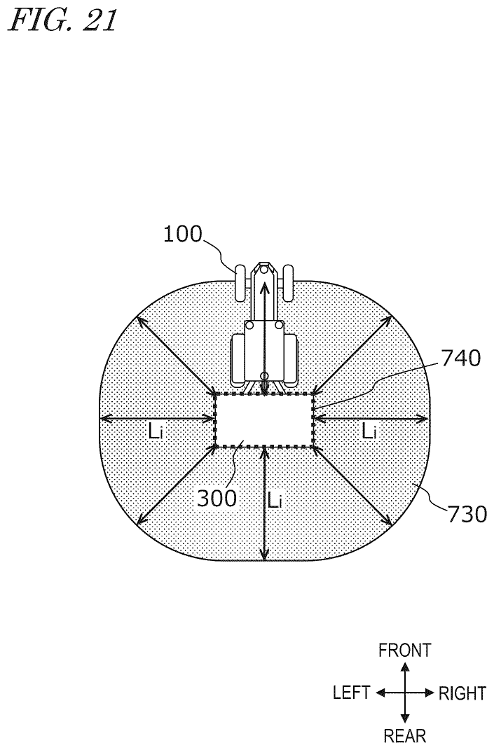

The processor 161 calculates the X coordinates of the front and rear ends of the implement 300 and also calculates the Y coordinates of the left and right ends of the implement 300 as described above. The processor 161 can use these coordinates to obtain data concerning the external shape 740 of a rectangle that is generally conformable to the external shape of the implement 300 (FIG. 21) and the coordinates of respective parts of the external shape 740. The external shape 740 of this rectangle passes through the front, rear, left and right ends of the implement 300.

FIG. 21 is a diagram showing an example of the alert zone 730 set around the implement 300.

The processor 161 sets a range of a predetermined distance from the calculated position of at least a portion of the external shape of the implement 300 as the alert zone 730. In the example shown in FIG. 21, a range of a predetermined distance Li from the external shape 740 is set as the alert zone 730 (step S204 of FIG. 18). The predetermined distance Li is, for example, 2 to 7 meters but is not limited to such a value.

While the implement 300 is performing work in a field, the processor 161 determines whether or not a human is present in the set alert zone 730 using sensor data output from one or more of the cameras 120, the obstacle sensor 130 and the LiDAR sensor 140 (step S205). When two or more types of sensors are used, a region which is difficult for one sensor to sense can be covered by a different sensor. For example, a blind spot area of the LiDAR sensor 140 can be covered by sensing with the use of the cameras 120 and/or the obstacle sensor 130.

The processor 161 estimates whether or not point cloud data representing a human is present in the three-dimensional point cloud data output from the LiDAR sensors 140 using, for example, an estimation model generated by machine learning, thereby determining whether or not a human is present in the alert zone 730. Also, for example, the processor 161 estimates whether or not image data representing a human is present in the image data output from the cameras 120 using an estimation model generated by machine learning, thereby determining whether or not a human is present in the alert zone 730. Such an estimation model is stored in advance in the storage device 170.

The processor 161 may determine whether or not a human is present in the alert zone 730 using both the three-dimensional point cloud data output from the LiDAR sensors 140 and the image data output from the cameras 120. For example, when it is determined using the three-dimensional point cloud data that an object is present which is highly probably a human, image data corresponding to the position of the object may be analyzed to further determine whether or not the object is human.

The processor 161 repeats the process of step S205 until a command to end the operation is given (step S206).

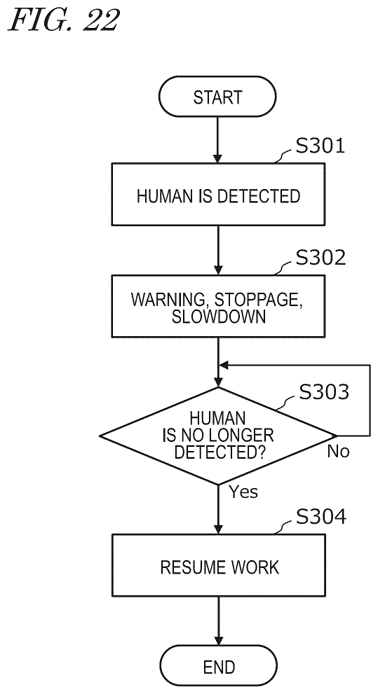

If it is determined that there is a human in the alert zone 730, the control system may be configured or programmed to control at least one of the following operations: issuance of a warning, stoppage of work of the implement 300, and slowdown of the work of the implement 300. FIG. 22 is a flowchart showing an example of a process that is performed if it is determined that a human is present in the alert zone 730.

If the processor 161 determines that a human is detected in the alert zone 730 (step S301), the controller 180 (FIG. 3) may be configured or programmed to control at least one of the following operations: issuance of a warning from the buzzer 220, stoppage of work of the implement 300, and slowdown of the work of the implement 300 (step S302). The controller 180 can stop or slow down the work of the implement 300 by stopping or slowing down the rotation of the PTO shaft. The controller 180 may communicate with the controller 380 of the implement 300 to stop or slow down the work of the implement 300. The controller 180 may stop or slow down the work of the implement 300 while emitting an alarm sound from the buzzer 220. In addition, the controller 180 may stop or slow down the traveling of the work vehicle 100 in parallel.

If the processor 161 determines that the human is no longer detected in the alert zone 730 because, for example, the human has moved away, the controller 180 may be configured or programmed to cause the implement 300 to resume the normal operation (step S304) and return to the process of step S206 shown in FIG. 18.

As described above, in the present example embodiment, implement information concerning a plurality of types of implements, which is provided by a plurality of users, is obtained, and the obtained implement information is accumulated in the server 600. The processor 161 retrieves implement information corresponding to the identification information of the implement 300 connected with the work vehicle 100 from the server 600 and sets the size of the alert zone 730 based on the retrieved implement information.

Thus, even when an implement is used of which the information necessary for setting the size of the alert zone 730 is not disclosed by the manufacturer, it is possible to set the size of the alert zone 730 suitable for each implement by using the implement information provided by the users.

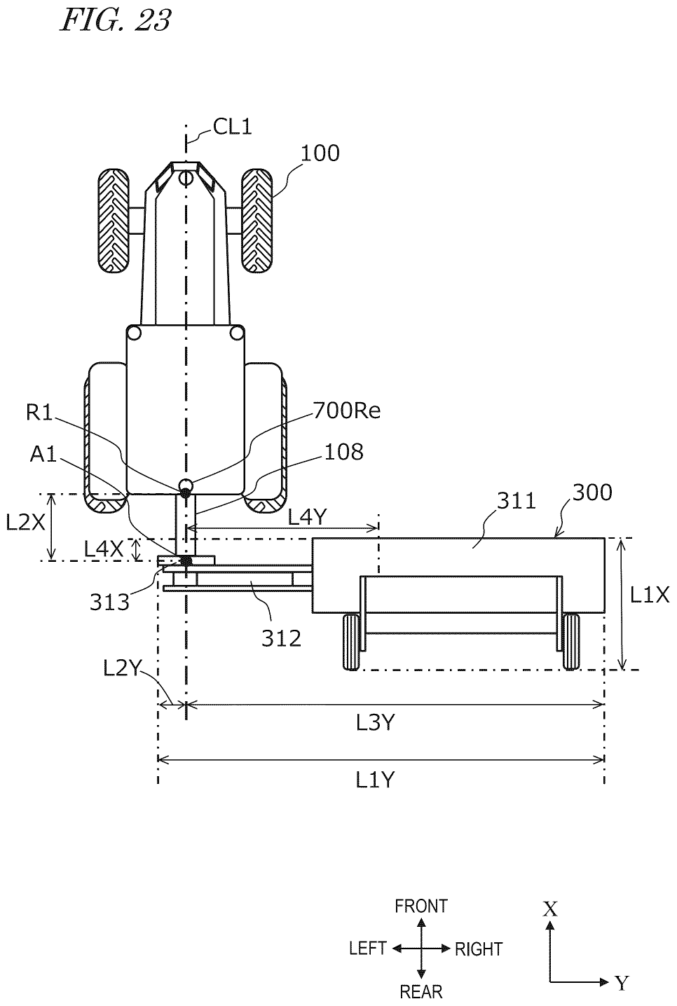

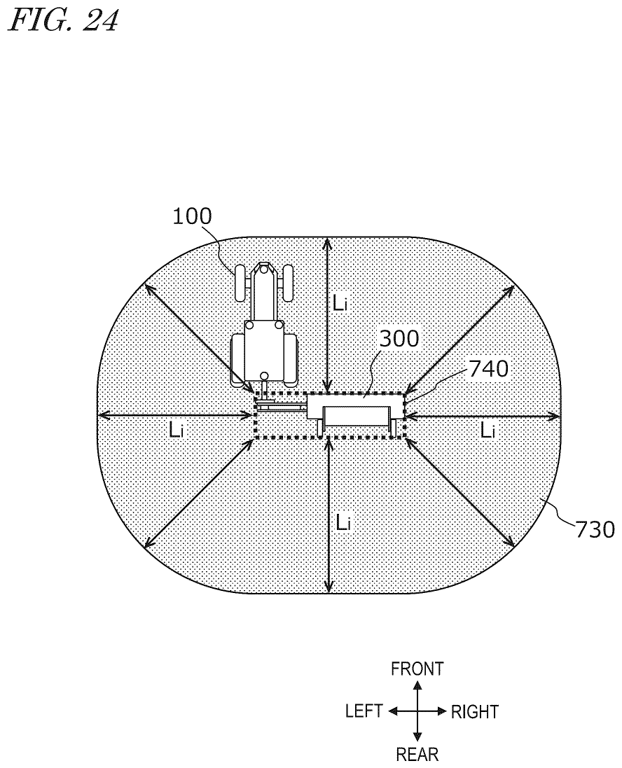

Next, setting of the alert zone 730 with consideration for offset is described. FIG. 23 is a diagram showing an example of the method of calculating the position of at least a portion of the external shape of the implement 300 in a local coordinate system.

In the example shown in FIG. 23, an offset-type mower, which is an example of the implement 300, is connected with the work vehicle 100.

The implement 300 shown in FIG. 23 includes a grass cutting section 311 for cutting grass and a linkage frame 312 attached to the grass cutting section 311. The linkage frame 312 has a shape that is elongated in the transverse direction, and the right portion of the linkage frame 312 and the left portion of the grass cutting section 311 are connected together. A linkage portion 313 provided at the left portion of the linkage frame 312 is connected with the linkage device 108.

The longitudinal offset length L4X refers to the length in the longitudinal direction between the front end of the implement 300 and the linkage portion. The transverse offset length L4Y refers to the length in the transverse direction between the transverse center of the implement 300 and the linkage portion.

The X coordinate of a rear-side position away from the reference point R1 by the value of the difference between the length L2X and the length L4X is equal to the X coordinate of the front end of the implement 300. The X coordinate of a rear-side position away from the X coordinate of the front end of the implement 300 by the length L1X is equal to the X coordinate of the rear end of the implement 300.

The value of the sum of ½ of the overall width L1Y and the offset length L4Y is equal to the length L3Y between the center line CL1 and the right end of the implement 300. The value of the difference between ½ of the overall width L1Y and the offset length L4Y is equal to the length L2Y between the center line CL1 and the left end of the implement 300. The Y coordinate of a left-side position away from the center line CL1 by the length L2Y is equal to the Y coordinate of the left end of the implement 300. The Y coordinate of a right-side position away from the center line CL1 by the length L3Y is equal to the Y coordinate of the right end of the implement 300.

The processor 161 calculates the X coordinates of the front and rear ends of the implement 300 and also calculates the Y coordinates of the left and right ends of the implement 300 as described above. The processor 161 can use these coordinates to obtain data concerning the external shape 740 of a rectangle that is generally conformable to the external shape of the implement 300 (FIG. 24) and the coordinates of respective portions of the external shape 740. The external shape 740 of this rectangle passes through the front, rear, left and right ends of the implement 300.

FIG. 24 is a diagram showing an example of the alert zone 730 set around the implement 300. In the example shown in FIG. 24, the processor 161 sets a range of a predetermined distance Li from the external shape 740 as the alert zone 730.

The predetermined distance Li may be changed according to the type of the implement 300 connected with the work vehicle 100. The processor 161 changes the predetermined distance Li according to the type of the implement 300 connected with the work vehicle 100. For example, when the implement 300 is a mower, the predetermined distance Li is larger than when the implement 300 is a tiller. The desirable distance of a human from the implement 300 can vary according to the type of the implement. By changing the predetermined distance Li according to the type of the implement 300, it is possible to set the size of the alert zone 730 suitable for the implement 300 connected with the work vehicle 100.

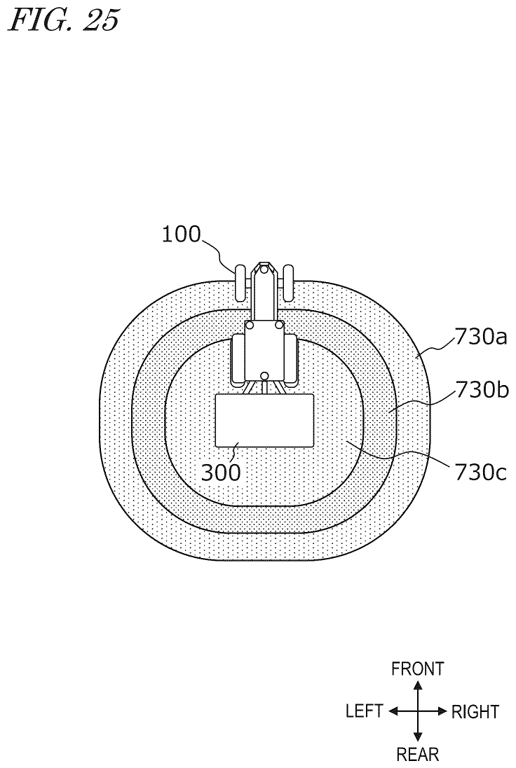

The alert zone 730 to be set is not limited to a single alert zone, but a plurality of alert zones 730 may be set. FIG. 25 is a diagram showing an example of a plurality of alert zones 730. In the example shown in FIG. 25, the processor 161 sets a plurality of alert zones 730a, 730b, 730c having different sizes. The alert zone 730a is the largest, the alert zone 730b is the second largest, and the alert zone 730c is the smallest.

The controller 180 varies the operation performed when a human is present in an alert zone among the plurality of alert zones 730a, 730b, 730c. For example, if the processor 161 determines that a human is present in the alert zone 730a while no human is present in the alert zones 730b and 730c, the controller 180 controls the buzzer 220 to emit an alarm sound. If the processor 161 determines that a human is present in the alert zone 730b while no human is present in the alert zone 730c, the controller 180 controls the buzzer 220 to emit an alarm sound and controls the implement 300 to slow down the work of the implement 300. If the processor 161 determines that a human is present in the alert zone 730c, the controller 180 controls the buzzer 220 to emit an alarm sound and controls the implement 300 to stop the work of the implement 300.

By varying the operation among a plurality of alert zones, it is possible to realize a suitable operation for the distance between the implement 300 and a human.

In the above-described example embodiments, the processor 161 retrieves the implementation information from the server 600 and sets the alert zone 730 using the retrieved implementation information. However, if the processor 161 fails to obtain the identification information of the implement 300, or if the implement information corresponding to the identification information is not stored in the server 600, it will be difficult to obtain the implement information from the server 600. In this case, the implement 300 may be sensed using the sensors 700 to detect the position of at least a portion of the external shape of the implement 300 in a local coordinate system.

If the processor 161 fails to obtain the identification information, or if the processor 161 fails to retrieve the implement information corresponding to the identification information, the processor 161 controls the sensors 700 to sense the implement 300. For example, the processor 161 controls the LiDAR sensor 140 to sense the implement 300. The three-dimensional point cloud data output from the LiDAR sensor 140 includes, for example, information concerning the coordinates of each of the plurality of points in a local coordinate system.

The processor 161 specifies point cloud data representing the implement 300 in the three-dimensional point cloud data output from the LiDAR sensors 140 using, for example, an estimation model generated by machine learning. The processor 161 calculates the coordinates of a plurality of positions on the external shape of the implement 300 using the information concerning the coordinates of each of a plurality of points included in the point cloud data representing the implement 300. The processor 161 sets a range of the predetermined distance Li from the calculated positions of the external shape of the implement 300 as the alert zone 730. Thus, the alert zone 730 can be set even if the processor 161 fails to obtain the identification information or if the processor 161 fails to retrieve the implement information from the server 600.

Note that the sensors to sense the implement 300 may be provided in other machines than the work vehicle 100. For example, a LiDAR sensor and/or camera mounted to a drone may be used to sense the implement 300. Alternatively, for example, a camera or the like installed in a storing place for the work vehicle 100 or in a field may be used to sense the implement 300.

The sensing system 10 of the present example embodiment can be mounted on or in an agricultural machine lacking such functions, as an add-on. Such a system may be manufactured and marketed independently from the agricultural machine. A computer program for use in such a system may also be manufactured and marketed independently from the agricultural machine. The computer program may be provided in a form stored in a non-transitory computer-readable storage medium, for example. The computer program may also be provided through downloading via telecommunication lines (e.g., the Internet).

A portion or all of the processes that are to be performed by the processor 161 in the sensing system 10 may be performed by another device. Such another device may be at least one of the processor 660 of the management device 600, the processor 460 of the terminal unit 400, and the operational terminal 200. In this case, such another device and the processor 161 function as a processor of the sensing system 10, or such another device functions as a processor of the sensing system 10. For example, when a portion of the processes that are to be performed by the processor 161 is performed by the processor 660 of the management device 600, the processor 161 and the processor 660 function as a processor of the sensing system 10.

A portion or all of the processes that are to be performed by the processor 161 may be performed by the controller 180. In this case, the controller 180 and the processor 161 may be configured or programmed to function as a processor of the sensing system 10, or the controller 180 may be configured or programmed to function as a processor of the sensing system 10.

As described above, the present disclosure includes agricultural management systems described below.

### Item 1

An agricultural management system 1 including a server 600 configured or programmed to obtain implement information concerning a plurality of types of implements from a plurality of users and storing the obtained implement information, and a processor 161 configured or programmed to set a size of an alert zone 730 around an implement 300 connected with a work vehicle 100, wherein the processor 161 is configured or programmed to obtain identification information which identifies the implement 300, retrieve implement information corresponding to the identification information from the server 600, and set the size of the alert zone 730 based on the retrieved implement information.

### Item 2

The agricultural management system 1 of Item 1, wherein the implement information corresponding to the identification information includes size information indicative of a size of the implement 300, and the processor 161 is configured or programmed to set the size of the alert zone 730 based on the size information.

### Item 3

The agricultural management system 1 of Item 2, wherein the processor 161 is configured or programmed to calculate a position of at least a portion of an external shape of the implement 300 connected with the work vehicle 100 based on the size information, and set the size of the alert zone 730 based on the calculated position of the at least a portion of the external shape of the implement 300.

### Item 4

The agricultural management system 1 of Item 3, wherein the processor 161 is configured or programmed to set a range of a predetermined distance Li from the calculated position of the at least a portion of the external shape of the implement 300 as the alert zone 730.

### Item 5

The agricultural management system 1 of Item 4, wherein the processor 161 is configured or programmed to change the predetermined distance Li according to a type of the implement 300 connected with the work vehicle 100.

### Item 6

The agricultural management system 1 of any of Items 1 to 5, further including a first sensor 700 to sense at least a portion of an external shape of the implement 300 and output sensor data, wherein if the processor 161 fails to obtain the identification information or if the processor 161 fails to retrieve the implement information corresponding to the identification information, the processor 161 is configured or programmed to set a size of the alert zone 730 based on the sensor data.

### Item 7

The agricultural management system 1 of any of Items 1 to 6, further including a second sensor 700 to sense the set alert zone 730 and output sensor data, and a controller 180 configured or programmed to determine whether or not a human is present in the set alert zone 730 based on the sensor data output from the second sensor 700 and, if the controller 180 determines that a human is present in the set alert zone 730, the controller 180 is configured or programmed to control at least one of the following operations issuance of a warning, stoppage of work of the implement 300, and slowdown of the work of the implement 300.

### Item 8

The agricultural management system 1 of any of Items 1 to 7, wherein the processor 161 is configured or programmed to set a plurality of alert zones 730 having different sizes, and the operation performed when a human is present in the alert zone 730 is varied among the plurality of alert zones 730.

### Item 9

The agricultural management system 1 of any of Items 1 to 8, wherein the processor 161 is provided in the work vehicle 100, the processor 161 is configured or programmed to request the implement information corresponding to the identification information from the server 600, the server 600 is configured or programmed to output the implement information requested by the processor 161, and the processor 161 is configured or programmed to obtain the implement information output from the server 600.

The techniques and example embodiments according to the present disclosure are particularly useful in the fields of agricultural machines, such as tractors, harvesters, rice transplanters, vehicles for crop management, vegetable transplanters, mowers, seeders, spreaders, or agricultural robots, for example.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An agricultural management system comprising:
a server configured or programmed to obtain implement information concerning a plurality of types of implements from a plurality of users and store the obtained implement information; and
a processor configured or programmed to set a size of an alert zone around a first implement connected with a work vehicle; wherein
the processor is configured or programmed to:
obtain identification information which identifies the first implement;
retrieve implement information corresponding to the identification information from the server; and
set the size of the alert zone based on the retrieved implement information.

2. The agricultural management system of claim 1, wherein
the implement information corresponding to the identification information includes size information indicative of a size of the first implement; and
the processor is configured or programmed to set the size of the alert zone based on the size information.

3. The agricultural management system of claim 2, wherein the processor is configured or programmed to:
calculate a position of at least a portion of an external shape of the first implement connected with the work vehicle based on the size information; and
set the size of the alert zone based on the calculated position of the at least a portion of the external shape of the first implement.

4. The agricultural management system of claim 3, wherein the processor is configured or programmed to set a range of a predetermined distance from the calculated position of the at least a portion of the external shape of the first implement as the alert zone.

5. The agricultural management system of claim 4, wherein the processor is configured or programmed to change the predetermined distance according to a type of the first implement connected with the work vehicle.

6. The agricultural management system of claim 1, further comprising a first sensor to sense at least a portion of an external shape of the first implement and output sensor data; wherein
when the processor fails to obtain the identification information or when the processor fails to retrieve the implement information corresponding to the identification information, the processor is configured or programmed to set a size of the alert zone based on the sensor data.

7. The agricultural management system of claim 1, further comprising:
a second sensor to sense the set alert zone and output sensor data; and
a controller configured or programmed to determine whether or not a human is present in the set alert zone based on the sensor data output from the second sensor and, when the controller determines that a human is present in the set alert zone, the controller is configured or programmed to control at least one of the following operations:
issuance of a warning;
stoppage of work of the first implement; or
slowdown of the work of the first implement.

8. The agricultural management system of claim 1, wherein
the processor is configured or programmed to set a plurality of alert zones having different sizes; and
the operation performed when a human is present in the alert zone is varied among the plurality of alert zones.

9. The agricultural management system of claim 1, wherein
the processor is provided in or on the work vehicle;
the processor is configured or programmed to request the implement information corresponding to the identification information from the server;
the server is configured or programmed to output the implement information requested by the processor; and
the processor is configured or programmed to obtain the implement information output from the server.
